(19) United States
(12) Patent Application Publication
(10) Pub. No.: US 2026/0270665 A1
(43) Pub. Date: Sep. 10, 2026

(54) DYNAMIC OFFLOADING VEHICLE-TO-EVERYTHING (V2X) MESSAGE PROCESSING TO EDGE AND PROCESSED INFORMATION RETRIEVING

(71) Applicant: Telefonaktiebolaget LM Ericsson (publ), Stockholm (SE)

(72) Inventors: Fengpei Zhang, Guangzhou, Guangdong (CN); Xinmei Ke, Guangzhou, Guangdong (CN)

(21) Appl. No.: 19/115,937

(22) PCT Filed: Sep. 28, 2022
(86) PCT No.: PCT/CN2022/122051

§ 371 Date: Mar. 27, 2025

(51) Int. Cl. H04W 4/40; H04L 67/12; H04W 72/51

(52) U.S. Cl. CPC H04W 4/40; H04L 67/12; H04W 72/51

(57) ABSTRACT

When offloading message processing to an edge node, systems and methods are provided that receive, from another terminal device, a V2X message; determine whether the received V2X message is to be processed by the edge node or not; and receive, from the edge node, a processing result for the V2X message in response to determining that the V2X message is to be processed by the edge node

### TECHNICAL FIELD

The present disclosure is related to the field of telecommunications, and in particular, to methods, terminal devices, and an edge note for dynamic offloading Vehicle-to-Everything (V2X) message processing to edge and processed information retrieving.

### BACKGROUND

V2X is a new generation of wireless communication technologies that enables data exchanges between vehicles and everything in their surroundings. V2X supports unified connectivity between connected entities in a V2X environment, such as vehicles, roadside equipments, and mobile devices, allowing them to transmit information such as their current speeds, positions, directions, etc. and make intelligent decisions. The technology creates an Intelligent Transportation System (ITS), transforming the experience of drivers, pedestrians, and transit riders by creating a more comfortable and safer transportation environment. It also has much significance in improving traffic efficiency and reducing greenhouse gas emissions and accident rates.

Typically, V2X supports several types of communications:
Vehicle-to-Vehicle (V2V) covers communication between two or more vehicles;
Vehicle-to-Pedestrian (V2P) covers the connection between vehicles and roadside users;
Vehicle-to-Infrastructure (V2I) is the communication between road entities and infrastructure units; and
Vehicle-to-Network (V2N) is the communication between vehicles and a communication network.

Due to the constrained on-board processing power in vehicular networks, it is difficult to raise the computing capacity of an individual vehicle for automotive applications. Therefore, a method for improving processing capacity for an individual vehicle is required.

### SUMMARY

According to a first aspect of the present disclosure, a method at a terminal device for offloading message processing to an edge node is provided. The method comprises that a V2X message is received from another terminal device. The method further comprises that whether a received V2X message is to be processed by the edge node or not is determined. The method further comprises that a processing result for the V2X message is received from the edge node in response to determining that the V2X message is to be processed by the edge node.

In some embodiments, the method further comprises that the V2X message is discarded in response to determining that the V2X message is to be processed by the edge node. In some embodiments, the method further comprises that the V2X message is processed locally in response to determining that the V2X message is not to be processed by the edge node. In some embodiments, the method further comprises that a first request message is transmitted to a first network node to discover an edge node to which processing of a V2X message can be offloaded. In some embodiments, the method further comprises that a first response message indicating one or more edge nodes to which processing of a V2X message can be offloaded is received from the first network node. In some embodiments, the first request message indicates at least one of: an identifier of the terminal device, one or more identifiers, each being associated with an application for which a V2X message is expected to be processed by the edge node, and an indicator indicating a current location of the terminal device. In some embodiments, the first response message indicates at least one of: an identifier of each of the one or more edge nodes, and endpoint information for each of the one or more edge nodes.

In some embodiments, before the step of receiving the V2X message, the method further comprises that a second request message is transmitted to the edge node to query the edge node for an offloading area. In some embodiments, the method further comprises that a second response message indicating a first geographical area where processing of a V2X message can be offloaded to the edge node is received from the edge node. In some embodiments, the second request message indicates at least one of: an identifier of the terminal device, an indicator indicating a planned location area where the terminal device will travel to, and an indicator indicating one or more V2X message types that are expected to be processed by the edge node. In some embodiments, the second response message indicates at least one of: an indicator indicating the first geographical area, and an indicator indicating one or more message types that are supported by the edge node.

In some embodiments, the step of determining whether the V2X message is to be processed by the edge node or not comprises that it is determined that the V2X message is to be processed by the edge node in response to determining that the V2X message has a message type that is supported by the edge node. In some embodiments, the step of determining whether the V2X message is to be processed by the edge node or not comprises that it is determined that the V2X message is not to be processed by the edge node in response to determining that the V2X message has a message type that is not supported by the edge node. In some embodiments, the step of determining whether the V2X message is to be processed by the edge node or not comprises that it is determined that the V2X message is not to be processed by the edge node in response to determining that the terminal device is not located in the first geographical area indicated by the edge node.

In some embodiments, the step of receiving, from the edge node, a processing result for the V2X message is performed in response to that a third request message for the processing result is transmitted to the edge node. In some embodiments, the third request message is one of: a request message for retrieving the processing result for one time only, and a request message for subscribing a periodical notification of the processing result. In some embodiments, when the third request message is a request message for retrieving the processing result for one time only, the third request message indicates at least one of: an identifier of the terminal device, and an indicator indicating a current location of the terminal device. In some embodiments, the processing result for the V2X message is indicated by a third response message in response to the third request message. In some embodiments, the third response message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, a list of one or more events associated with the V2X object.

In some embodiments, when the third request message is a request message for subscribing a periodical notification of the processing result, the third request message indicates at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method further comprises that a third response message indicating a subscription identifier is received from the edge node in response to the third request message. In some embodiments, the processing result of the V2X message is indicated by a notification message received from the edge node. In some embodiments, the notification message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, and a list of one or more events associated with the V2X object.

In some embodiments, the method further comprises that a target edge node to which the terminal device is switched for offloading message processing is determined. In some embodiments, the method further comprises that a fourth request message is transmitted to the target edge node to query the target edge node for an offloading area. In some embodiments, the method further comprises that a fourth response message indicating a third geographical area where processing of a V2X message can be offloaded to the target edge node is received from the target edge node. In some embodiments, the fourth request message indicates at least one of: an identifier of the terminal device, an indicator indicating a planned location area where the terminal device will travel to, and an indicator indicating one or more V2X message types that are expected to be processed by the target edge node. In some embodiments, the fourth response message indicates at least one of: an indicator indicating the third geographical area, and an indicator indicating one or more message types that are supported by the target edge node.

According to a second aspect of the present disclosure, a terminal device is provided. The terminal device comprises: a processor and a memory storing instructions which, when executed by the processor, cause the processor to perform any of the methods of the first aspect.

According to a third aspect of the present disclosure, a terminal device for offloading message processing to an edge node is provided. The terminal device comprises a receiving module configured to receive, from another terminal device, a V2X message. The terminal device further comprises a determining module configured to determine whether a received V2X message is to be processed by the edge node or not. The terminal device further comprises a receiving module configured to receive, from the edge node, a processing result for the V2X message in response to determining that the V2X message is to be processed by the edge node. In some embodiments, the terminal device comprises one or more further modules, each of which may perform any of the steps of the method of the first aspect.

According to a fourth aspect of the present disclosure, a method at an edge node for facilitating a terminal device in offloading message processing to the edge node is provided. The method comprises that a received V2X message is processed. The method further comprises that a third request message for a processing result for the V2X message is received from a terminal device. The method further comprises that a processing result for the V2X message is transmitted to the terminal device in response to the third request message.

In some embodiments, the third request message is one of: a request message for retrieving the processing result for one time only, and a request message for subscribing a periodical notification of the processing result. In some embodiments, when the third request message is a request message for retrieving the processing result for one time only, the third request message indicates at least one of: an identifier of the terminal device, and an indicator indicating a current location of the terminal device. In some embodiments, the processing result for the V2X message is indicated by a third response message in response to the third request message. In some embodiments, the third response message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, a list of one or more events associated with the V2X object.

In some embodiments, when the third request message is a request message for subscribing a periodical notification of the processing result, the third request message indicates at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method further comprises that a third response message indicating a subscription identifier is transmitted to the terminal device in response to the third request message. In some embodiments, the processing result of the V2X message is indicated by a notification message transmitted by the edge node. In some embodiments, the notification message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, and a list of one or more events associated with the V2X object.

In some embodiments, before the step of receiving the third request message, the method further comprises that a second request message is received from the terminal device to query the edge node for an offloading area. In some embodiments, the method further comprises that a second response message indicating a first geographical area where processing of a V2X message can be offloaded to the edge node is transmitted to the terminal device. In some embodiments, the first geographical area is determined at least based on one or more fourth geographical areas, each of which is a geographical area where a relay terminal device, which is registered with the edge node, can listen to a V2X message over PC5. In some embodiments, the second request message indicates at least one of: an identifier of the terminal device, an indicator indicating a planned location area where the terminal device will travel to, and an indicator indicating one or more V2X message types that are expected to be processed by the edge node. In some embodiments, the second response message indicates at least one of: an indicator indicating the first geographical area, and an indicator indicating one or more message types that are supported by the edge node.

In some embodiments, before the step of receiving the V2X message, the method further comprises that a fifth request message is transmitted to a first network node to register the edge node with the first network node. In some embodiments, the method further comprises that a fifth request message indicating whether the registration is successful or not is received from the first network node in response to the fifth request message. In some embodiments, the fifth request message indicates at least one of: an identifier of the edge node, endpoint information for the edge node, and an indicator indicating a fifth geographical area where the edge node can serve. In some embodiments, the fifth response message indicates an identifier associated with the registration of the edge node.

In some embodiments, before the step of receiving the V2X message, the method further comprises that a sixth request message is received from a relay terminal device to register the relay terminal device with the edge node. In some embodiments, the method further comprises that a sixth response message indicating whether the registration is successful or not is transmitted to the relay terminal device in response to the sixth request message. In some embodiments, the sixth request message indicates at least one of: an identifier of the relay terminal device, and an indicator indicating a fourth geographical area where the relay terminal device can listen to a V2X message over PC5. In some embodiments, the sixth response message indicates at least one of: an identifier associated with the registration of the relay terminal device, and an indicator indicating one or more message types to be relayed by the relay terminal device. In some embodiments, the V2X message is received via the relay terminal device.

According to a fifth aspect of the present disclosure, an edge node is provided. The edge node comprises: a processor and a memory storing instructions which, when executed by the processor, cause the processor to perform any of the methods of the fourth aspect.

According to a sixth aspect of the present disclosure, an edge node for facilitating a terminal device in offloading message processing to the edge node is provided. The edge node comprises a processing module configured to process a received V2X message. The edge node further comprises a receiving module configured to receive, from a terminal device, a third request message for a processing result for the V2X message. The edge node further comprises a transmitting module configured to transmit, to the terminal device, a processing result for the V2X message in response to the third request message. In some embodiments, the edge node comprises one or more further modules, each of which may perform any of the steps of the method of the fourth aspect.

According to a seventh aspect of the present disclosure, a method at a relay terminal device for facilitating a terminal device in offloading message processing to an edge node is provided. The method comprises that a V2X message destined to the terminal device is received and/or transmitted. The method comprises that whether the V2X message is to be processed by the edge node or not is determined. The method further comprises that the V2X message is transmitted to the edge node in response to determining that the V2X message is to be processed by the edge node.

In some embodiments, the method further comprises that the V2X message is discarded in response to determining that the V2X message is not to be processed by the edge node. In some embodiments, the step of determining whether the V2X message is to be processed by the edge node or not comprises that it is determined that the V2X message is to be processed by the edge node in response to determining that the V2X message has a message type that is supported by the edge node. In some embodiments, the step of determining whether the V2X message is to be processed by the edge node or not comprises that it is determined that the V2X message is not to be processed by the edge node in response to determining that the V2X message has a message type that is not supported by the edge node. In some embodiments, the method further comprises that a seventh request message is transmitted to a first network node to discover an edge node to which processing of a V2X message can be offloaded. In some embodiments, the method further comprises that a seventh response message indicating one or more edge nodes to which processing of a V2X message can be offloaded is received from the first network node. In some embodiments, the seventh request message indicates at least one of: an identifier of the relay terminal device, one or more identifiers, each being associated with an application for which a V2X message is expected to be processed by the edge node, and an indicator indicating a current location of the relay terminal device. In some embodiments, the seventh response message indicates at least one of: an identifier of each of the one or more edge nodes, and endpoint information for each of the one or more edge nodes.

In some embodiments, the method further comprises that a sixth request message is transmitted to the edge node to register the relay terminal device with the edge node. In some embodiments, the method further comprises that a sixth response message indicating whether the registration is successful or not is received from the edge node in response to the sixth request message. In some embodiments, the sixth request message indicates at least one of: an identifier of the relay terminal device, and an indicator indicating a fourth geographical area where the relay terminal device can listen to a V2X message over PC5. In some embodiments, the sixth response message indicates at least one of: an identifier associated with the registration of the relay terminal device, and an indicator indicating one or more message types to be relayed by the relay terminal device.

According to an eighth aspect of the present disclosure, a relay terminal device is provided. The relay terminal comprises: a processor and a memory storing instructions which, when executed by the processor, cause the processor to perform any of the methods of the seventh aspect.

According to a ninth aspect of the present disclosure, a relay terminal device for facilitating a terminal device in offloading message processing to an edge node is provided. The relay terminal device comprises a communicating module configured to receive and/or transmit a V2X message destined to the terminal device. The relay terminal device further comprises a determining module configured to determine whether the V2X message is to be processed by the edge node or not. The relay terminal device further comprises a transmitting module configured to transmit, to the edge node, the V2X message in response to determining that the V2X message is to be processed by the edge node. In some embodiments, the relay terminal device comprises one or more further modules, each of which may perform any of the steps of the method of the seventh aspect.

According to a tenth aspect of the present disclosure, a method at a terminal device for obtaining a processing result for one or more V2X messages from an edge network is provided. The method comprises that an eighth request message for a processing result for one or more V2X messages is transmitted to an edge node in the edge network. The method further comprises that the processing result is received from the edge node in response to the eighth request message.

In some embodiments, the eighth request message is one of: a request message for retrieving the processing result for one time only, and a request message for subscribing a periodical notification of the processing result. In some embodiments, when the eighth request message is a request message for retrieving the processing result for one time only, the eighth request message indicates at least one of: an identifier of the terminal device, and an indicator indicating a current location of the terminal device. In some embodiments, the processing result is indicated by an eighth response message in response to the eighth request message. In some embodiments, the eighth response message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, and a list of one or more events associated with the V2X object.

In some embodiments, when the eighth request message is a request message for subscribing a periodical notification of the processing result, the eighth request message indicates at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method further comprises that an eighth response message indicating a subscription identifier is received from the edge node in response to the eighth request message. In some embodiments, the processing result is indicated by a notification message received from the edge node. In some embodiments, the notification message indicates at least one of: an indicator indicating a second geographical area relevant to the current location of the terminal device, a timestamp, a list of one or more V2X objects, and a list of one or more events. In some embodiments, a V2X object indicates at least one of: a type of the V2X object, a location associated with the V2X object, additional information associated with the V2X object, and a list of one or more events associated with the V2X object.

In some embodiments, the method further comprises that a ninth request message is transmitted to a first network node to discover an edge node from which a processing result for V2X messages can be retrieved. In some embodiments, the method further comprises that a ninth response message indicating one or more edge nodes from which a processing result for V2X messages can be retrieved is received from the first network node. In some embodiments, the ninth request message indicates at least one of: an identifier of the terminal device, one or more identifiers, each being associated with an application for which a processing result for V2X messages is expected to be retrieved from the edge node, and an indicator indicating a current location of the terminal device. In some embodiments, the ninth response message indicates at least one of: an identifier of each of the one or more edge nodes, and endpoint information for each of the one or more edge nodes.

In some embodiments, before the step of transmitting the eighth request message, the method further comprises that a tenth request message is transmitted to the edge node to query the edge node for an information retrieval area. In some embodiments, the method further comprises that a tenth response message indicating a sixth geographical area where a processing result for V2X messages can be retrieved from the edge node is received from the edge node. In some embodiments, the tenth request message indicates at least one of: an identifier of the terminal device, an indicator indicating a planned location area where the terminal device will travel to, and an indicator indicating one or more V2X message types for which a processing result for V2X messages is expected to be retrieved from the edge node. In some embodiments, the tenth response message indicates at least one of: an indicator indicating the sixth geographical area, and an indicator indicating one or more message types that are supported by the edge node.

In some embodiments, the method further comprises that it is determined a target edge node to which the terminal device is switched for retrieving the processing result. In some embodiments, the method further comprises that an eleventh request message is transmitted to the target edge node to query the target edge node for an information retrieval area. In some embodiments, the method further comprises an eleventh response message indicating a seventh geographical area where the processing result can be retrieved from the target edge node is received from the target edge node. In some embodiments, the eleventh request message indicates at least one of: an identifier of the terminal device, an indicator indicating a planned location area where the terminal device will travel to, and an indicator indicating one or more V2X message types for which a processing result for V2X messages is expected to be retrieved from the target edge node. In some embodiments, the eleventh response message indicates at least one of: an indicator indicating the seventh geographical area, and an indicator indicating one or more message types that are supported by the target edge node. In some embodiments, the terminal device itself does not support V2X communication.

According to an eleventh aspect of the present disclosure, a terminal device is provided. The terminal device comprises: a processor and a memory storing instructions which, when executed by the processor, cause the processor to perform any of the methods of the tenth aspect.

According to a twelfth aspect of the present disclosure, a terminal device for obtaining a processing result for one or more V2X messages from an edge network is provided. The terminal device comprises a transmitting module configured to transmit, to an edge node in the edge network, an eighth request message for a processing result for one or more V2X messages. The terminal device further comprises a receiving module configured to receive, from the edge node, the processing result in response to the eighth request message. In some embodiments, the terminal device comprises one or more further modules, each of which may perform any of the steps of the method of the tenth aspect.

According to a thirteenth aspect of the present disclosure, a computer program comprising instructions is provided. The instructions, when executed by at least one processor, cause the at least one processor to carry out any of the methods of the first aspect, the fourth aspect, the seventh aspect, and the tenth aspect.

According to a fourteenth aspect of the present disclosure, a carrier containing the computer program of the thirteenth aspect is provided. In some embodiments, the carrier is one of an electronic signal, optical signal, radio signal, or computer readable storage medium.

According to a fifteenth aspect of the present disclosure, a telecommunications system is provided. The telecommunications system comprises one or more terminal devices of the second or third aspect, one or more edge nodes of the fifth or sixth aspect, and one or more relay terminal devices of the eighth or ninth aspect. In some embodiments, the telecommunications system further comprises one or more terminal devices of the eleventh or twelfth aspect.

With the embodiments of the present disclosure, V2X message processing tasks of a vehicle may be offloaded when needed to ensure the computation efficiency and driving safety. Further, legacy vehicles that have no PC5 support can still be benefited from the V2X message processing in the edge.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary Cellular-V2X (C-V2X) telecommunications network in which dynamic offloading V2X message processing and processed information retrieving may be applicable according to an embodiment of the present disclosure.

FIG. 2 is a diagram illustrating an exemplary Vehicle-to-Vehicle (V2V) network in which dynamic offloading V2X message processing and processed information retrieving may be applicable according to an embodiment of the present disclosure.

FIG. 3 is a diagram illustrating an exemplary Vehicle-to-Edge-to-Vehicle (V2E2V) network in which dynamic offloading V2X message processing and processed information retrieving may be applicable according to an embodiment of the present disclosure.

FIG. 4 is a diagram illustrating an exemplary system for dynamic offloading V2X processing to an edge node and retrieving processed information from the edge node according to an embodiment of the present disclosure.

FIG. 5 is a diagram illustrating an exemplary procedure for a Road Side Unit (RSU) to register itself with an Edge Application Server (EAS) according to an embodiment of the present disclosure.

FIG. 6 is a diagram illustrating an exemplary procedure for a vehicle to discover an EAS according to an embodiment of the present disclosure.

FIG. 7 is a diagram illustrating an exemplary procedure for service continuity for a vehicle according to an embodiment of the present disclosure.

FIG. 8 is a diagram illustrating an exemplary procedure for offloading V2X message processing according to an embodiment of the present disclosure.

FIG. 9 is a diagram illustrating an exemplary procedure for retrieving processed information according to an embodiment of the present disclosure.

FIG. 10 is a diagram illustrating an exemplary procedure for a legacy vehicle to discover an EAS according to an embodiment of the present disclosure.

FIG. 11 is a diagram illustrating an exemplary procedure for service continuity for a legacy vehicle according to an embodiment of the present disclosure.

FIG. 12 is a diagram illustrating an exemplary procedure for determining a serving area for a legacy vehicle processing according to an embodiment of the present disclosure.

FIG. 13 is a diagram illustrating an exemplary procedure for a legacy vehicle to retrieve processed information according to an embodiment of the present disclosure.

FIG. 14 is a flow chart illustrating an exemplary method at a terminal device for offloading message processing to an edge node according to an embodiment of the present disclosure.

FIG. 15 is a flow chart illustrating an exemplary method at an edge node for facilitating a terminal device in offloading message processing to an edge node according to an embodiment of the present disclosure.

FIG. 16 is a flow chart illustrating an exemplary method at a relay terminal device for facilitating a terminal device in offloading message processing to an edge node according to an embodiment of the present disclosure.

FIG. 17 is a flow chart illustrating an exemplary method at a terminal device for obtaining a processing result for one or more V2X messages from an edge network according to an embodiment of the present disclosure.

FIG. 18 schematically shows an embodiment of an arrangement which may be used in terminal devices or an edge node according to an embodiment of the present disclosure.

FIG. 19 is a block diagram illustrating an exemplary terminal device according to an embodiment of the present disclosure.

FIG. 20 is a block diagram illustrating an exemplary edge node according to an embodiment of the present disclosure.

FIG. 21 is a block diagram illustrating an exemplary relay terminal device according to an embodiment of the present disclosure.

FIG. 22 is a block diagram illustrating another exemplary terminal device according to another embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as dynamic offloading V2X processing and processed information retrieving are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, or any other equivalents.

As mentioned above, V2X is a technology that allows vehicles to communicate with any entity that may affect the vehicle, and vice versa. V2X may consist of more specific types of communication as V2I (vehicle-to-infrastructure), V2N (vehicle-to-network), V2V (vehicle-to-vehicle), V2P (vehicle-to-pedestrian) etc.

C-V2X allows a C-V2X device to use the cellular network connection in the traditional manner over Uu interface. Uu refers to the logical interface between a UE and a base station. This is generally referred to as V2N.

However, due to the huge amount of message exchanges especially for V2V communication, 3GPP also introduces PC5 interface (also known as “slidelink” in 3GPP RAN specification) to support direct communication between C-V2X devices to improve the C-V2X efficiency.

V2X is also essential for safe and efficient autonomous driving. For example, V2X communication can alert the autonomous driving vehicle about objects it cannot directly see (non-line-of-sight).

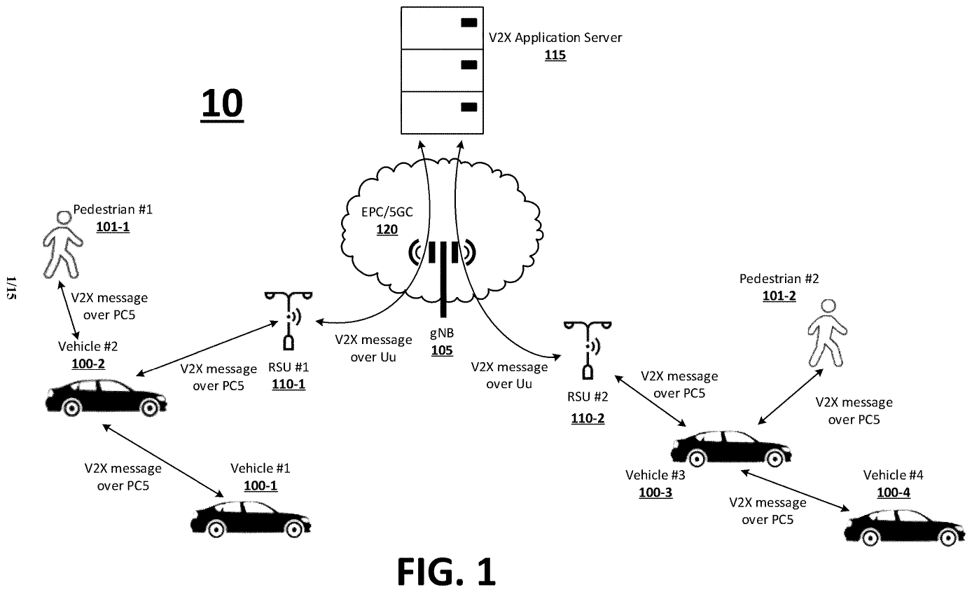

FIG. 1 is a diagram illustrating an exemplary C-V2X telecommunications network 10 in which dynamic offloading V2X message processing and processed information retrieving may be applicable according to an embodiment of the present disclosure. As shown in FIG. 1, the network 10 may comprise at least one of: one or more vehicles 100-1 through 100-4 (collectively, the vehicles 100), one or more pedestrians (and terminal devices attached to or carried by the pedestrians) 101-1 and 101-2 (collectively, the pedestrians 101), one or more RSUs 110-1 and 110-2 (collectively, the RSUs 110), a gNB 105, a core network (e.g., an EPC or a 5GC) 120, and a V2X application server 115. Please note that the present disclosure is not limited thereto. In some other embodiments, different numbers and/or different types of the entities may be present in the network 10. For example, the network 10 may comprise one or more of drones, lane markings, road signs, and traffic lights, or the like. Further, the term “terminal device” used herein may refer to any of a vehicle, a pedestrian (or a device associated therewith), and an RSU shown in FIG. 1, or any other similar entity.

As shown in FIG. 1, a vehicle (e.g., the vehicle 100-1) may communicate with another vehicle (e.g., the vehicle 100-2) via V2V over the PC5 interface or reference point. As also shown in FIG. 1, a vehicle (e.g., the vehicle 100-2) may communicate with a pedestrian (e.g., the pedestrian 101-1) via V2P over the PC5 interface or reference point. As further shown in FIG. 1, a vehicle (e.g., the vehicle 100-2) may communicate with an RSU (e.g., the RSU 110-1) via V2I over the PC5 interface or reference point. As also shown in FIG. 1, an RSU (e.g., the RSU 110-1) may communicate with a gNB (e.g., the gNB 105) via V2N over the Uu interface or reference point. Further, other entities may communicate with each other in similar manners as described above. In other words, the terminal devices (e.g., the vehicles 100, the pedestrians 101, and/or the RSUs 110) shown in FIG. 1 may communicate with each other via V2X over the PC5/Uu interface. In this way, a terminal device (e.g., the vehicle 100-1) in the network 10 may communicate with the V2X application server 115, for example, via the vehicle #2 100-2, the RSU 110-1, the gNB 105, and the EPC/5GC 120, and information, such as, vehicle information (e.g., speed, location, vehicle type, etc.), navigation information, traffic information, entertainment information, can be exchanged therebetween.

Edge Computing as an evolution of cloud computing brings application hosting from centralized data centers down to the network edge, closer to consumers and the data generated by applications, especially when latency and bandwidth efficiency are concerned.

Edge computing plays an essential role in the transformation of the telecommunications business, where telecommunications networks are turning into versatile service platforms for industry and other specific customer segments. This transformation is supported by edge computing, as it opens the network edge for applications and services, including those from third parties.

With the increasing number of intelligent applications (e.g., augmented reality and autonomous driving vehicles) that require much more computational power, they have needs to shift to perform computation offloading to the cloud. As Edge Computing extends the cloud to the edge of the network, close to end users, bringing ultra-low latency and high bandwidth, computation offloading toward edge cloud becomes a trend.

In V2V communication, a vehicle will process received V2V messages by itself. Since the messages are transmitted using broadcasting and the message processing is completely distributed without relying on any server-side capabilities, V2V is cost-efficient for large-scale deployment.

However, on dense roads, transmission of a greater number of V2V messages can create a processing bottleneck at receiving vehicles. This may create potentially harmful outcomes if the critical V2V messages fail to be processed on time. The processing bottleneck at receiving vehicles includes:
Verification of digital signatures;
Message content plausibility check;
Filtering non-relevant messages;
Filtering duplicated events.

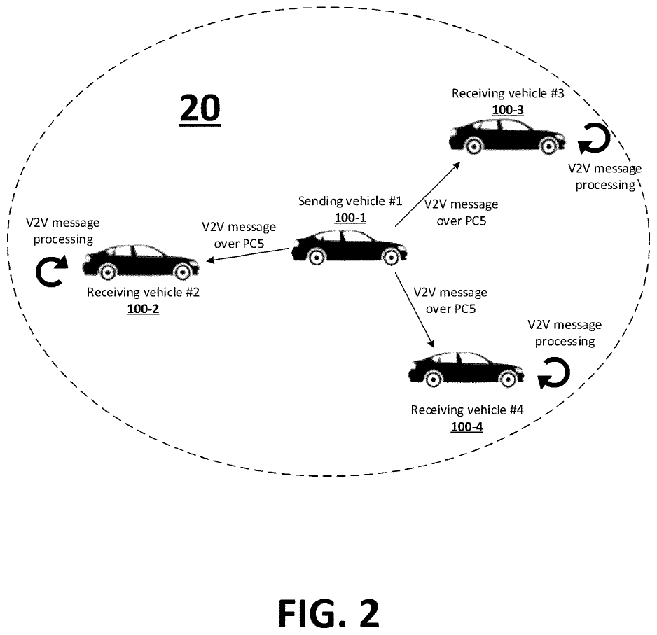

This bottleneck becomes even worse when a vehicle is overloaded by other computational tasks, such as AI/ML for autonomous driving or facing a low energy level. FIG. 2 is a diagram illustrating an exemplary V2V network 20 in which dynamic offloading V2X message processing and processed information retrieving may be applicable according to an embodiment of the present disclosure. As shown in FIG. 2, the network 20 may comprise multiple vehicles 100-1 through 100-4, and one of them, the sending vehicle 100-1, sends a V2V message while other vehicles 100-2 through 100-4 receive and process the V2X message.

As clearly shown in FIG. 2, the processing of the same V2V message is repeated at multiple vehicles (e.g., the vehicles 100-2 through 100-4) for more than one time, potentially resulting in a bottleneck in terms of processing capacity at one or more of the vehicles. For example, if some vehicle (e.g., the vehicle 100-2) is being overloaded by other computation tasks and the received V2V message is critical (e.g., a sudden braking by the vehicle 100-1 which is closely located in front of the vehicle 100-2), then it is very dangerous for the vehicle 100-2 to be unable to process and respond to the V2V message in time.

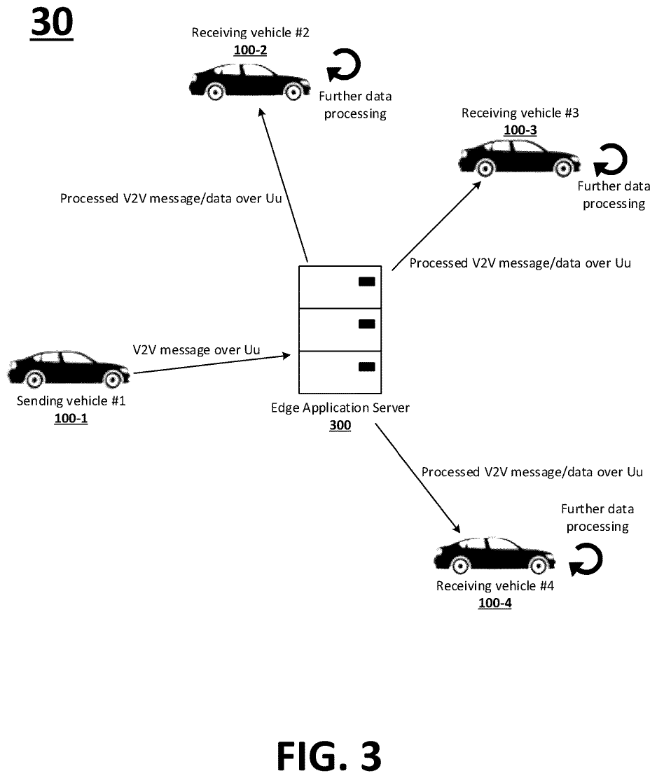

FIG. 3 is a diagram illustrating an exemplary Vehicle-to-Network-to-Vehicle (V2N2V) network 30 in which dynamic offloading V2X message processing and processed information retrieving may be applicable according to an embodiment of the present disclosure.

As shown in FIG. 3, a vehicle (e.g., the vehicle 100-1) can also logically communicate with another vehicle (e.g., the vehicle 100-2, 100-3, or 100-4) through a network server over Uu interface of a cellular network, which is so called “V2N2V”.

According to 5GAA's view, safety critical services that require guaranteed low latency reliable communications should be supported by short range communications, including PC5. More delay tolerant services can also be delivered over V2N2V. However, as the introduction of 5G and Edge Computing, services requiring low latency and high reliability could also be provided over Uu. In some embodiments of the present disclosure, this can be called as Vehicle-to-Edge-to-Vehicle (V2E2V). For example, the network server shown in FIG. 3 may be an edge node (e.g., an Edge Application Server (EAS)) 300, and therefore the network 30 may also be known as a V2E2V network 30.

As shown in FIG. 3, the network 30 may comprise multiple vehicles 100-1 through 100-4 and an Edge Application Server (EAS) 300. One of vehicles, the sending vehicle 100-1 sends a V2V message to the EAS 300 via Uu interface. In such a case, the EAS 300 may process the V2V message, and provide the processed V2V message to other vehicles 100-2 through 100-4 for further data processing. Unlike FIG. 2, the processing of the same V2V message is performed at the EAS 300 only once, resulting in an efficient usage of processing power. In other words, the V2E2V solution can offload the message processing from the vehicles 100 to the EAS 300.

However, firstly, since the messages are sent through Uu interface, it will bring a heavy burden to the cellular network. Secondly, as the V2E2V solution relies on edge computing infrastructure and server-side capabilities, it may make large-scale deployment more difficult. Below please find a summary of pros and cons for different solutions.

TABLE 1
Comparison of V2V and V2E2V

| | V2V | V2E2V |
|---|---|---|
| Pros | Broadcasting based, not flooding Uu. | Offload the message processing of |
| | Message processing is fully distributed. | vehicles yet ensure low latency |
| | Cost-efficient for large-scale | reliable communications. |
| | deployment. | |
| Cons | When in-vehicle message processing | Uu-based communication may |
| | become a bottleneck, it may potentially | flood the cellular network. |
| | harm the safety of the vehicles. | Rely on edge computing |
| | | infrastructure and server-side |
| | | capabilities. |
| | | Not cost-efficient for large-scale |
| | | deployment. |

By comparing these two solutions, it is believed that a hybrid and inventive solution can combine the advantages and addressing the challenges.

Some embodiments of the present disclosure may provide an opportunity for a vehicle to dynamically offload the V2X message processing to the edge when the in-vehicle computation become a bottleneck. Further, when a vehicle does not need offloading, it can still fallback to regular V2X message processing locally.

In some embodiments, a hybrid solution to combine V2V and V2E2V is provided. In some embodiments, an RSU may play an important role by listening and forwarding V2X messages to corresponding EAS for processing. In some embodiments, as an EAS collects V2X messages, a vehicle inside its serving area can request for offloading the V2X message processing to the edge.

With some embodiments of the present disclosure, V2X message processing tasks of a vehicle may be offloaded when needed to ensure the computation efficiency and driving safety. Further, legacy vehicles that have no PC5 support can still be benefited from the V2X message processing in the edge.

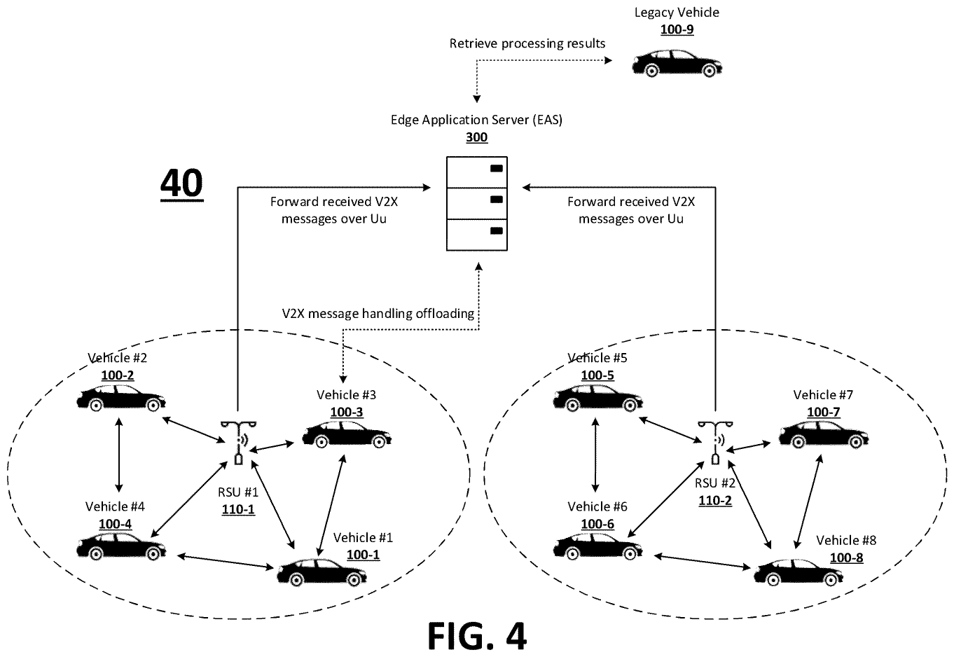

FIG. 4 is a diagram illustrating an exemplary system 40 for dynamic offloading V2X processing to an edge node and retrieving processed information from the edge node according to an embodiment of the present disclosure. As shown in FIG. 4, the system 40 may comprise one or more terminal devices (e.g., vehicles 100-1 through 100-9, or collectively the vehicles 100), one or more RSUs 110-1 and 110-2 (collectively, the RSU 110), and an edge network comprising one or more edge nodes (e.g., an EAS) 300. Please note that the present disclosure is not limited thereto. In some other embodiments, different numbers and/or different types of the entities may be present in the system 40. For example, the system 40 may comprise one or more of pedestrians, gNBs, network functions, drones, lane markings, road signs, and traffic lights, or the like, which are not shown in FIG. 4.

As shown in FIG. 4, a vehicle (e.g., the vehicle 100-3) may communicate with another vehicle (e.g., the vehicle 100-1) via V2V over the PC5 interface or reference point. As also shown in FIG. 4, a vehicle (e.g., the vehicle 100-3) may communicate with an RSU (e.g., the RSU 110-1) via V2I over the PC5 interface or reference point. As further shown in FIG. 4, an RSU (e.g., the RSU 110-1) may communicate with an edge node (e.g., the EAS 300) via V2N over the Uu interface or reference point (e.g., via a gNB) and also via other optional interfaces, such as, N3, N6, Naf (e.g., a User Plane Function (UPF), an Application Function (AF)). Further, other entities may communicate with each other in similar manners as described above. In other words, the terminal devices (e.g., the vehicles 100 and/or the RSUs 110) shown in FIG. 4 may communicate with each other via V2X over the PC5/Uu interface. In this way, a terminal device (e.g., the vehicles 100 and/or the RSUs 110) in the system 40 may communicate with the EAS 300. However, the present disclosure is not limited thereto, and other interfaces and/or paths not shown in FIG. 4 may also be applicable.

Further, as shown in FIG. 4, a vehicle (e.g., the vehicle 100-3) may communicate with the EAS 300 via its Uu interface, rather than its PC5 interface, as indicated by the dotted double arrow therebetween. Furthermore, as also shown in FIG. 4, a legacy vehicle (e.g., the legacy vehicle 100-9) may communicate with the EAS 300 via its Uu interface, for example, because the legacy vehicle cannot or would not support PC5 communication, as indicated by the dotted double arrow therebetween.

Some embodiments of the present disclosure are to provide an opportunity for a vehicle (e.g., the vehicle 100-3) to dynamically offload the V2X message processing to Edge (e.g., the EAS 300). In order to do so, in some embodiments, the system 40 may behave as below:
A vehicle (e.g., the vehicle 100-1) always sends V2X messages over PC5;
An RSU (e.g., the RSU 110-1) may be configured to listen to the PC5 interface and then forward the received V2X messages to EAS (e.g., the EAS 300) for processing. Furthermore, the RSU may be configured to forward the V2X messages to EAS depends on the message types. For example, the RSU may only forward non-time-critical messages (e.g., road hazard, traffic situation) to EAS.
After collecting the V2X messages forwarded by multiple RSUs, EAS can process the messages and serve the vehicles that have offloading need in a specific geographical area.
If a vehicle is on “fallback” mode, it will process all the received V2X messages by itself.
If a vehicle is on “offloading” mode, it may:
   Ignore the messages supported by edge processing and retrieve the processed data from EAS instead.
   Only keep handling the unsupported messages locally.

With this solution, a vehicle can build a strategy to dynamically offload V2X message processing tasks (together with other computational tasks) to the edge in order to optimize the overall efficiency.

In some embodiments, a vehicle or terminal device may dynamically determine what percentage of its processing tasks shall be offloaded to the edge. For example, when the terminal device has a high load level, then it may offload a higher percentage of its processing tasks to the edge while processing only the time-critical tasks. For another example, when the terminal device has a low load level, then it may offload a lower percentage of its processing tasks to the edge, or even process all the tasks locally.

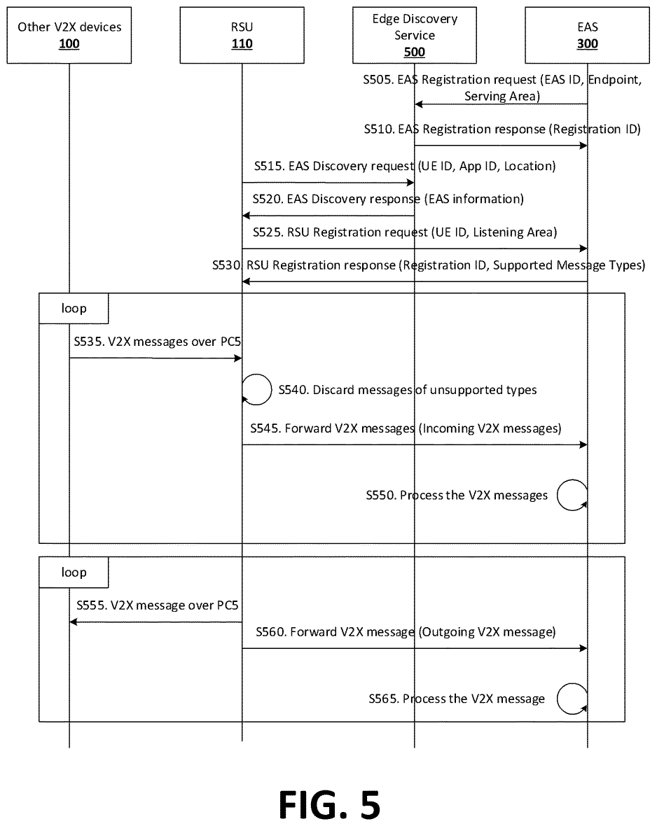

FIG. 5 is a diagram illustrating an exemplary procedure for an RSU 110 to register itself with an EAS 300 according to an embodiment of the present disclosure. Please note that some steps of this procedure are optional and therefore can be omitted or replaced with other steps.

At step S505, the EAS 300 may send an “EAS Registration” request to an Edge Discovery Service (EDS) 500. In some embodiments, the request may include at least one of:
“EAS ID” which may be the identity of the EAS 300;
“Endpoint” which may indicate endpoint information (e.g., a URL) through which a device application on a UE (a UE could be a vehicle or an RSU) can access the EAS 300; and
“Serving Area” which may indicate a geographical area where the EAS 300 can serve a device application on a UE.

At step S510, the Edge Discovery Service 500 may send an “EAS Registration” response back to the EAS 300 with a “Registration ID” which may be the identity of this registration.

With the steps S505 and S510, the EAS 300 may be registered at the EDS 500, such that it can be discovered by another entity through the EDS 500. However, the present disclosure is not limited thereto. In some other embodiments, the registration information of the EAS 300 may be pre-configured at the EDS 500 and/or the RSU 110, which means that the steps S505 and S510 may be omitted.

At step S515, after the RSU 110 is installed and powered on, the RSU 110 may send an “EAS Discovery” request to the Edge Discovery Service 500. In some embodiments, the request may include at least one of:
“UE ID” which may be the identity of the UE (that is, the RSU 110), e.g., MSISDN;
“App ID” which may be the identity of the device application on the RSU 110; and
“Location” which may be the location of the RSU 110.

In some other embodiments, more than one App IDs may be provided by the RSU 110 to the EDS 500, such that the EDS 500 may provide the RSU 110 with an edge node (e.g., the EAS 300) that supports all of the device applications indicated by the more than one App IDs, or an edge node that supports most of them, some of them, or at least one of them.

At step S520, the Edge Discovery Service 500 may send an “EAS Discovery” response back to the RSU 110. In some embodiments, the response may include “EAS information” which may contain at least one of:
“EAS ID” which may be the identity of the EAS 300; and
“Endpoint” which may indicate the endpoint information (e.g., URL) through which the device application on the RSU 110 can access the EAS 300.

With the steps S515 and S520, the RSU 110 may discover an edge node or EAS 300 that can provide the RSU 110 with the offloading functionality. However, the present disclosure is not limited thereto. In some other embodiments, the information of the EAS 300 (e.g., its endpoint information) may be pre-configured at the RSU 110 since both of them are typically installed at fixed locations, which means that the steps S515 and S520 may be omitted.

At step S525, the RSU 110 may send an “RSU Registration” request to the EAS 300. In some embodiments, the request may include at least one of:
“UE ID” which may be the identity of the UE (that is, the RSU 110), e.g., MSISDN; and
“Listening Area” which may indicate a geographical area where the RSU 110 can listen to V2X messages over PC5.

At step S530, the EAS 300 may send an “RSU Registration” response back to the RSU 110, and the response may include at least one of:
With a “Registration ID” which may be the identity of this registration.
With a “Support Message Types” list to guide RSU 110 in subsequent message filtering.

With the steps S525 and S530, the RSU 110 may register itself with the EAS 300 and one or more certain types of V2X messages can be forwarded to the EAS 300 via the RSU 110 for subsequent processing and offloading. However, the present disclosure is not limited thereto. In some other embodiments, the information of the RSU 110 (e.g., its listening area) may be pre-configured at the EAS 300 since both of them are typically installed at fixed locations, which means that the steps S525 and S530 may be omitted.

At step S535, the RSU 110 may receive V2X messages sent from other V2X devices 100 over PC5.

At step S540, the RSU 110 may discard messages of unsupported types, and at step S545, the RSU 110 may forward those incoming V2X messages to the EAS 300, for example, over its Uu interface. In some embodiments, the RSU 110 can buffer the received V2X messages before forwarding. In some embodiments, the interval of RSU 110 forwarding may be at a 10 ms level (which can be supported by the Edge) while V2X messages may be sent at intervals greater than 100 ms. In such a case, the 10 ms level forwarding interval can ensure the low latency for the entire procedure.

At step S550, the EAS 300 may process the received V2X messages. In some embodiments, the processing may include at least one of:
Verification of digital signatures;
Message content plausibility check;
Filtering duplicated events; and
Maintaining a snapshot view including V2X objects and events inside the serving areas.

Please note that the steps S535 through S550 may be repeated for each incoming V2X messages received by the RSU 110. However, the present disclosure is not limited thereto. In some other embodiments, the step S545 may be performed once when multiple V2X messages are received and buffered by the RSU 110 to reduce network resources occupied, for example, if they are not time-critical messages. For another example, the EAS 300 may process the received V2X messages once when multiple V2X messages are received, for example, if they are not time-critical messages.

Similarly, at step S555, the RSU 110 may broadcast a V2X message to other V2X devices 100 over PC5. In such a case, at step S560, the RSU 110 may forward this outgoing V2X message to the EAS 300, for example, over Uu. At step S565, the EAS 300 may process the received V2X message (the same as step S550).

Please also note that the steps S555 through S565 may be repeated for each outgoing V2X messages transmitted by the RSU 110. However, the present disclosure is not limited thereto. In some other embodiments, the step S560 may be performed once when multiple V2X messages are transmitted and buffered by the RSU 110 to reduce network resources occupied, for example, if they are not time-critical messages. For another example, the EAS 300 may process the received V2X messages once when multiple V2X messages are received, for example, if they are not time-critical messages.

With the procedure shown in FIG. 5, one or more RSUs can be registered to an edge node, and V2X messages may be forwarded to the edge node via the registered RSUs. Further, by providing the listening areas associated with the RSUs, the EAS 300 may determine its source of the received V2X messages, and can dynamically adjust its serving area or other configurations, which can be used for example in the procedures described below.

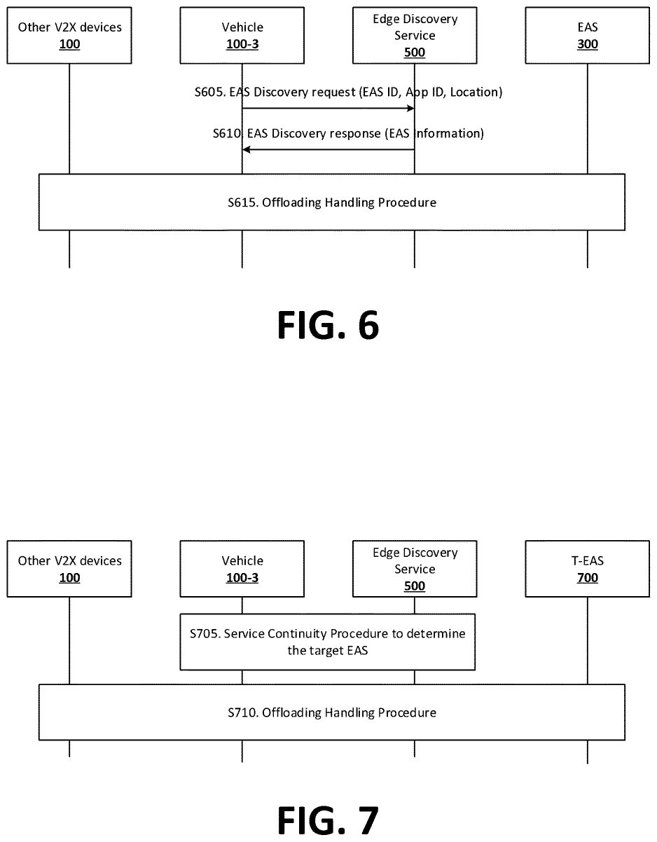

FIG. 6 is a diagram illustrating an exemplary procedure for a vehicle 100-3 to discover an EAS 300 according to an embodiment of the present disclosure. Please note that some steps of this procedure are optional and therefore can be omitted or replaced with other steps.

At step S605, when the vehicle 100-3 intents to offload the V2X message processing to the edge, the vehicle 100-3 may send an “EAS Discovery” request to the Edge Discovery Service 500. In some embodiments, the request may include at least one of:
“UE ID” which may be the identity of the UE (that is, the vehicle 100-3), e.g., MSISDN;
“App ID” which may be the identity of a device application on the vehicle 100-3; and
“Location” which may be the current location of the vehicle 100-3.

In some other embodiments, more than one App IDs may be provided by the vehicle 100-3 to the EDS 500, such that the EDS 500 may provide the vehicle 100-3 with an edge node (e.g., the EAS 300) that supports all of the device applications indicated by the more than one App IDs, or an edge node that supports most of them, some of them, or at least one of them.

At step S610, the Edge Discovery Service 500 may send an “EAS Discovery” response back to the vehicle 100-3. In some embodiments, the response may include “EAS information” which may contain at least one of:
“EAS ID” which may be the identity of the EAS 300; and
“Endpoint” which may indicate the endpoint information (e.g., URL) through which a device application on the vehicle 100-3 can access the EAS 300.

With the steps S605 and S610, the vehicle 100-3 may discover an edge node or EAS 300 that can provide the vehicle 100-3 with the offloading functionality. However, the present disclosure is not limited thereto. In some other embodiments, the information of the EAS 300 (e.g., its endpoint information) may be pre-configured at the vehicle 100-3, for example, when the vehicle 100-3 and the EAS 300 are operated by a same operator or collaborative partners, which means that the steps S605 and S610 may be omitted.

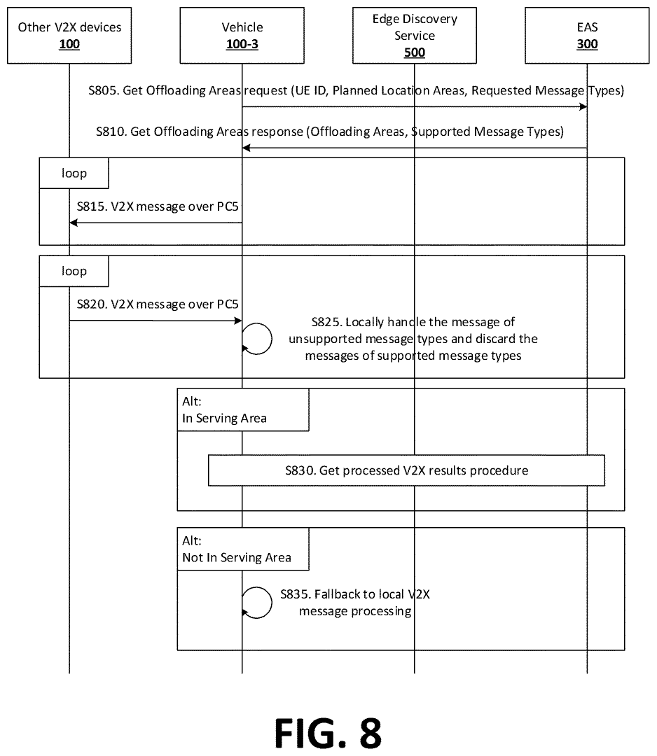

At step S615, the vehicle 100-3 may trigger the offloading handling sub-procedure. A detailed description of the offloading handling sub-procedure is provided with reference to FIG. 8 below.

FIG. 7 is a diagram illustrating an exemplary procedure for service continuity for a vehicle 100-3 according to an embodiment of the present disclosure. Please note that some steps of this procedure are optional and therefore can be omitted or replaced with other steps.

At step S705, when the vehicle 100-3 switches edge (e.g., moving out of the serving area of the current edge node), the edge computing system may assist the vehicle 100-3 and the EAS 300 for service continuity. During this procedure, the Edge Discovery Service 500 may be used to determine the target EAS (T-EAS) 700, for example, by the steps S605 and S610 shown in FIG. 6. Once the T-EAS 700 is determined, the edge computing system may notify the vehicle 100-3.

At step S710, when the vehicle 100-3 is notified of the T-EAS information, the vehicle 100-3 may trigger the offloading handling sub-procedure with the T-EAS 700. A detailed description of the offloading handling sub-procedure is provided with reference to FIG. 8 below.

FIG. 8 is a diagram illustrating an exemplary procedure for offloading V2X message processing according to an embodiment of the present disclosure. Please note that some steps of this procedure are optional and therefore can be omitted or replaced with other steps.

At step S805, the vehicle 100-3 may send a “Get Offloading Areas” request to the EAS 300 to retrieve the geographical areas where offloading the V2X message processing is supported. In some embodiments, the request may include at least one of:
“UE ID” which may be the identity of the UE (that is, the vehicle 100-3), e.g., MSISDN; and
Optionally, “Planned Location Area” which may indicate the planned location area where the vehicle 100-3 will travel to.
Optionally, “Requested Message Types” which may indicate the message types that expect the edge to process.

At step S810, the EAS 300 may send a “Get Offloading Areas” response back to the vehicle 100-3. In some embodiments, the response may include the “Offloading Areas” and/or “Supported Message Types”. Please notice that “Supported Message Types” may be different from “Requested Message Types” in previous step S805. With the steps S805 and S810, the vehicle 100-3 may determine the serving areas of the EAS 300, and therefore can handle the received V2X message in a more reasonable manner. However, the present disclosure is not limited thereto. In some other embodiments, the vehicle 100-3 may assume that it can be always served by the EAS 300 until an edge switching (e.g., that shown in FIG. 7) is triggered, which means that the steps S805 and S810 may be omitted.

At step S815, if the vehicle 100-3 wants to send V2X messages to other V2X devices 100 (e.g., the vehicle 100-1), it may broadcast them over PC5 no matter it is in offloading mode or fallback mode (that is, in the serving area of the EAS 300 or not).

At step S820, the vehicle 100-3 may receive V2X messages from other V2X devices 100.

At step S825, the vehicle 100-3 may still locally handle the messages of unsupported message types and discard the messages of supported message types.

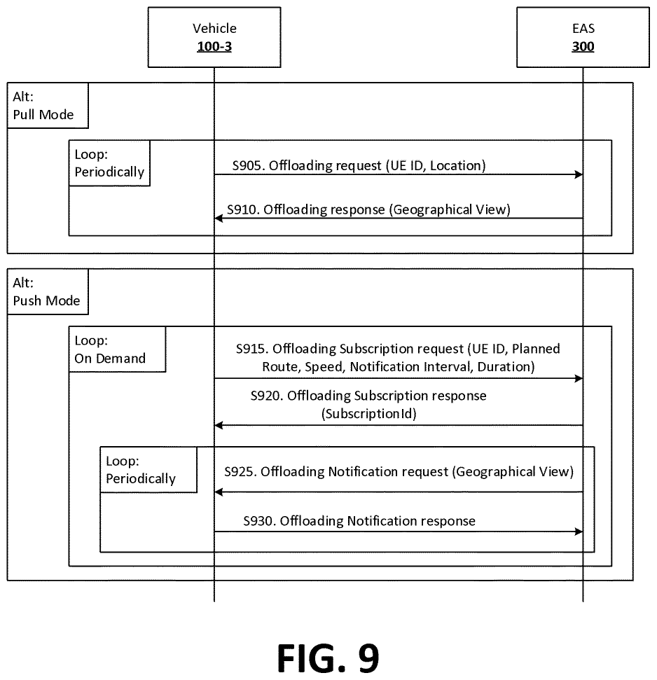

At step S830, if the vehicle 100-3 is inside an offloading area, it may perform “Get Processed V2X Results” procedure to get the processed V2X results from EAS 300. An exemplary “Get Processed V2X Results” procedure will be described below with reference to FIG. 9.

At step S835, if the vehicle 100-3 is not inside an offloading area, it may fallback to local V2X message processing. In other words, the vehicle 100-3 may process the received V2X messages locally.

With the procedure shown in FIG. 8, the vehicle 100-3 may offload its processing of some of the V2X messages (that can be supported by the EAS 300) to the EAS 300, and processing power may be saved at the vehicle 100-3.

FIG. 9 is a diagram illustrating an exemplary procedure for retrieving processed information according to an embodiment of the present disclosure. Please note that some steps of this procedure are optional and therefore can be omitted or replaced with other steps.

As shown in FIG. 9, there are two modes for a vehicle 100-3 to get processed V2X results from EAS 300:

### Pull Mode:

At step S905, the vehicle 100-3 may send an “Offloading” request to the EAS 300. In some embodiments, the request may include at least one of: UE ID and the current location of the vehicle 100-3. In some embodiments, the interval may be in 100 millisecond level.

At step S910, the EAS 300 may send an “Offloading” response back to the vehicle 100-3. In some embodiments, the response may include a “Geographic View” object which may contain a list of V2X objects and/or events within a geographic area around the current vehicle location. An exemplary definition of “GeographicalView” data type is provided below.

### Push Mode:

At step S915, the vehicle 100-3 may send an “Offloading Subscription” request to the EAS 300. In some embodiments, the request may include at least one of: UE ID, a planned route where the vehicle 100-3 may travel along within the subscription duration, notification interval, and subscription duration. Optionally, the request may include the vehicle speed of the vehicle 100-3 for EAS 300 to predict the location of the vehicle 100-3.

At step S920, the EAS 300 may send an “Offloading Subscription” response back to the vehicle 100-3. In some embodiments, the response may include a subscription ID.

At step S925, periodically, according to the notification interval, EAS 300 may send an “Offloading Notification” request to the vehicle 100-3. In some embodiments, the request may include the subscription ID, and a “GeographicalView” object within a geographic area either covering the whole planned route or around the predicted vehicle location.

At step S930, the vehicle 100-3 may send an “Offloading Notification” response back to the EAS 300.

TABLE 2
DataType: GeographicalView

| Information element | Status | Description |
|---|---|---|
| GeographicalArea | M | The geographical area of the view. |
| Timestamp | M | The timestamp of the view. |
| List of V2X Objects | O | The V2X objects inside this geographical area. |
| >Type | M | The type of the V2X object (e.g., Vehicle/RSU/ |
| | | Pedestrian). |
| >Location | M | The location of the V2X object. |
| >Object Information | M | The additional information the V2X object. |
| >List of Events | O | The events associated with the V2X object (e.g., |
| | | emergency brake). |
| >>Type | M | The type of the event. |
| >>Event Information | M | The additional information of the event. |
| List of Events | O | The events not associated with any V2X object |
| | | (e.g., road hazard). |
| >Type | M | The type of the event. |
| >Location | M | The location where the event happened. |
| >Event Information | M | The additional information of the event. |

With the procedure described with reference to FIG. 9, a vehicle may obtain the processing result of one or more V2X message that are offloaded to an EAS. In other words, the vehicle itself needs not to perform the processing of the V2X message by itself, and therefore the processing power can be used for processing more important tasks, such as, time-critical tasks.

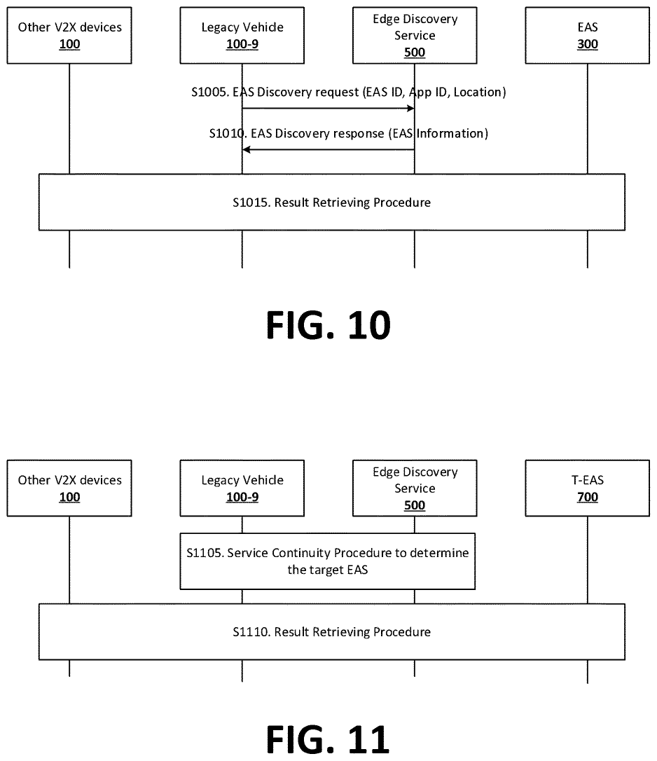

FIG. 10 is a diagram illustrating an exemplary procedure for a legacy vehicle 100-9 to discover an EAS 300 according to an embodiment of the present disclosure. Please note that some steps of this procedure are optional and therefore can be omitted or replaced with other steps. In some embodiments, the legacy vehicle 100-9 does not support V2X communication, and therefore cannot obtain any information via V2X messages.

At step S1005, when the legacy vehicle 100-9 intents to retrieve processing results of V2X messages (e.g., V2X messages generated by nearby vehicles) from the edge, the vehicle 100-9 may send an “EAS Discovery” request to the Edge Discovery Service 500. In some embodiments, the request may include at least one of:
“UE ID” which may be the identity of the UE (that is, the vehicle 100-9), e.g., MSISDN;
“App ID” which may be the identity of a device application on the vehicle 100-9; and
“Location” which may be the current location of the vehicle 100-9.

In some other embodiments, more than one App IDs may be provided by the vehicle 100-9 to the EDS 500, such that the EDS 500 may provide the vehicle 100-9 with an edge node (e.g., the EAS 300) that supports all of the device applications indicated by the more than one App IDs, or an edge node that supports most of them, some of them, or at least one of them.

At step S1010, the Edge Discovery Service 500 may send an “EAS Discovery” response back to the vehicle 100-9. In some embodiments, the response may include “EAS information” which may contain at least one of:
“EAS ID” which may be the identity of the EAS 300; and
“Endpoint” which may indicate the endpoint information (e.g., URL) through which a device application on the vehicle 100-9 can access the EAS 300.

With the steps S1005 and S1010, the vehicle 100-9 may discover an edge node or EAS 300 that can provide the vehicle 100-9 with the processed information (e.g., processing results for V2X messages). However, the present disclosure is not limited thereto. In some other embodiments, the information of the EAS 300 (e.g., its endpoint information) may be pre-configured at the vehicle 100-9, for example, when the vehicle 100-9 and the EAS 300 are operated by a same operator or collaborative partners, which means that the steps S1005 and S1010 may be omitted.

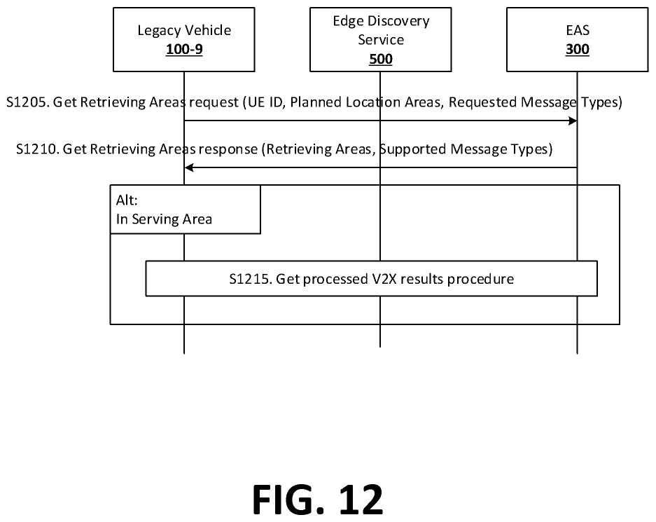

At step S1015, the vehicle 100-9 may trigger the result retrieving sub-procedure. A detailed description of the result retrieving sub-procedure is provided with reference to FIG. 12 below.

FIG. 11 is a diagram illustrating an exemplary procedure for service continuity for a legacy vehicle 100-9 according to an embodiment of the present disclosure. Please note that some steps of this procedure are optional and therefore can be omitted or replaced with other steps.

At step S1105, when the vehicle 100-9 switches edge (e.g., moving out of the serving area of the current edge node), the edge computing system may assist the vehicle 100-9 and the EAS 300 for service continuity. During this procedure, the Edge Discovery Service 500 may be used to determine the target EAS (T-EAS) 700, for example, by the steps S1005 and S1010 shown in FIG. 10. Once the T-EAS 1100 is determined, the edge computing system may notify the vehicle 100-9.

At step S1110, when the vehicle 100-9 is notified of the T-EAS information, the vehicle 100-9 may trigger the result retrieving sub-procedure with the T-EAS 700. A detailed description of the result retrieving sub-procedure is provided with reference to FIG. 12 below.

FIG. 12 is a diagram illustrating an exemplary procedure for a legacy vehicle 100-9 to retrieve processing result for V2X messages according to an embodiment of the present disclosure. Please note that some steps of this procedure are optional and therefore can be omitted or replaced with other steps.

At step S1205, the vehicle 100-9 may send a “Get Retrieving Areas” request to the EAS 300 to retrieve the geographical areas where retrieving processing results for V2X messages is supported. In some embodiments, the request may include at least one of:
“UE ID” which may be the identity of the UE (that is, the vehicle 100-9), e.g., MSISDN; and
Optionally, “Planned Location Area” which may indicate the planned location area where the vehicle 100-9 will travel to.
Optionally, “Requested Message Types” which may indicate the message types that expect the edge to process and provide a corresponding result.

At step S1210, the EAS 300 may send a “Get Retrieving Areas” response back to the vehicle 100-9. In some embodiments, the response may include the “Retrieving Areas” and/or “Supported Message Types”. Please notice that “Supported Message Types” may be different from “Requested Message Types” in previous step S1205.

With the steps S1205 and S1210, the vehicle 100-9 may determine the serving areas of the EAS 300, and therefore can avoid retrieving information when it is in a non-serving area. However, the present disclosure is not limited thereto. In some other embodiments, the vehicle 100-9 may assume that it can be always served by the EAS 300 until an edge switching (e.g., that shown in FIG. 11) is triggered, which means that the steps S1205 and S1210 may be omitted.

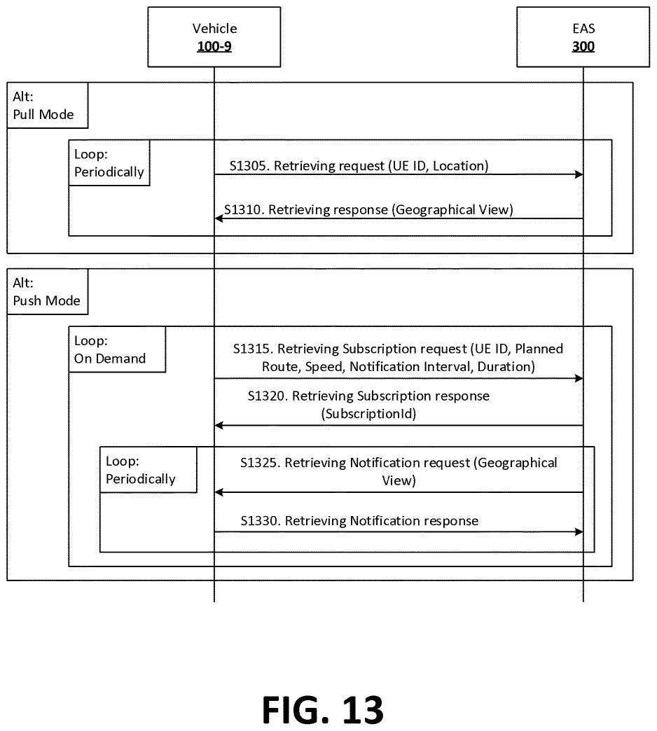

At step S1215, if the vehicle 100-9 is inside a retrieving area, it may perform “Get Processed V2X Results” procedure to get the processed V2X results from EAS 300. An exemplary “Get Processed V2X Results” procedure will be described below with reference to FIG. 13. Further, if the vehicle 100-9 is not inside a retrieving area, it may just do nothing about it since it may not support V2X communication. Alternatively, if the vehicle 100-9 supports V2X communication, it can still process the V2X messages locally without offloading the processing of the V2X messages to the EAS 300 when it is not located in a retrieving area.

With the procedure shown in FIG. 12, the vehicle 100-9 may retrieving processing results for V2X messages, and benefit from the retrieved information, for example, information indicating a road hazard ahead of the vehicle 100-9.

FIG. 13 is a diagram illustrating an exemplary procedure for a legacy vehicle 100-9 to retrieve processed information according to an embodiment of the present disclosure. Please note that some steps of this procedure are optional and therefore can be omitted or replaced with other steps.

As shown in FIG. 13, there are two modes for a vehicle 100-9 to get processed V2X results from EAS 300:

### Pull Mode:

At step S1305, the vehicle 100-9 may send a “Retrieving” request to the EAS 300. In some embodiments, the request may include at least one of: UE ID and the current location of the vehicle 100-9. In some embodiments, the interval may be in 100 millisecond level.

At step S1310, the EAS 300 may send a “Retrieving” response back to the vehicle 100-9. In some embodiments, the response may include a “GeographicalView” object which may contain a list of V2X objects and/or events within a geographic area around the current vehicle location. An exemplary definition of “GeographicalView” data type is provided above in Table 2.

### Push Mode:

At step S1315, the vehicle 100-9 may send a “Retrieving Subscription” request to the EAS 300. In some embodiments, the request may include at least one of: UE ID, a planned route where the vehicle 100-9 may travel along within the subscription duration, notification interval, and subscription duration. Optionally, the request may include the vehicle speed of the vehicle 100-9 for EAS 300 to predict the location of the vehicle 100-9.

At step S1320, the EAS 300 may send a “Retrieving Subscription” response back to the vehicle 100-9. In some embodiments, the response may include a subscription ID.

At step S1325, periodically, according to the notification interval, EAS 300 may send a “Retrieving Notification” request to the vehicle 100-9. In some embodiments, the request may include the subscription ID, and a “GeographicalView” object within a geographic area either covering the whole planned route or around the predicted vehicle location. An exemplary definition of “GeographicalView” data type is provided above in Table 2.

At step S1330, the vehicle 100-9 may send a “Retrieving Notification” response back to the EAS 300.

With the procedure described with reference to FIG. 13, a legacy vehicle may also obtain the processing result of one or more V2X message that are received by an EAS. In other words, the vehicle itself needs not to perform or even support the processing of the V2X message, and therefore even a legacy vehicle that does not support V2X communication can still benefit from the solution described above.

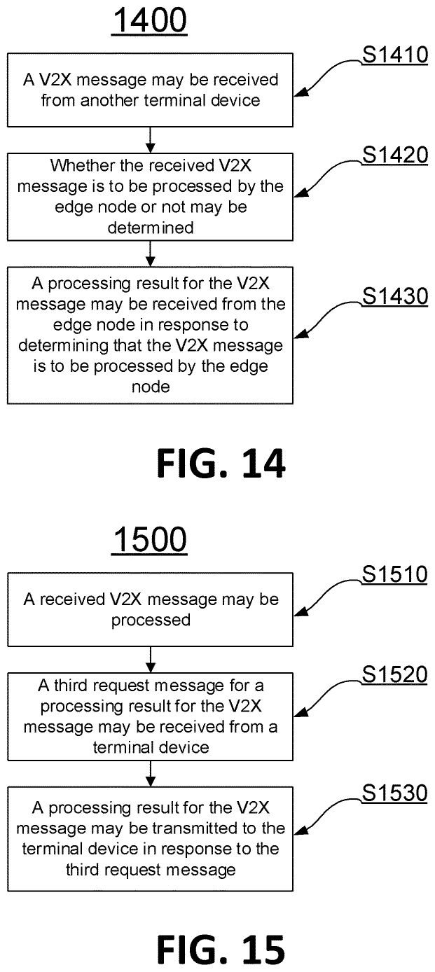

FIG. 14 is a flow chart of an exemplary method 1400 at a terminal device for offloading message processing to an edge node according to an embodiment of the present disclosure. The method 1400 may be performed at a terminal device (e.g., the vehicle 100-3 shown in FIG. 4). The method 1400 may comprise steps S1410, S1420, and S1430. However, the present disclosure is not limited thereto. In some other embodiments, the method 1400 may comprise more steps, less steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin at step S1410 where a V2X message may be received from another terminal device.

At step S1420, whether a received V2X message is to be processed by the edge node or not may be determined.

At step S1430, a processing result for the V2X message may be received from the edge node in response to determining that the V2X message is to be processed by the edge node.

In some embodiments, the method 1400 may further comprise that the V2X message may be discarded in response to determining that the V2X message is to be processed by the edge node. In some embodiments, the method 1400 may further comprise that the V2X message may be processed locally in response to determining that the V2X message is not to be processed by the edge node. In some embodiments, the method 1400 may further comprise that a first request message may be transmitted to a first network node to discover an edge node to which processing of a V2X message can be offloaded. In some embodiments, the method 1400 may further comprise that a first response message indicating one or more edge nodes to which processing of a V2X message can be offloaded may be received from the first network node. In some embodiments, the first request message may indicate at least one of: an identifier of the terminal device, one or more identifiers, each being associated with an application for which a V2X message is expected to be processed by the edge node, and an indicator indicating a current location of the terminal device. In some embodiments, the first response message may indicate at least one of: an identifier of each of the one or more edge nodes, and endpoint information for each of the one or more edge nodes.

In some embodiments, before the step of receiving the V2X message, the method 1400 may further comprise that a second request message may be transmitted to the edge node to query the edge node for an offloading area. In some embodiments, the method 1400 may further comprise that a second response message indicating a first geographical area where processing of a V2X message can be offloaded to the edge node may be received from the edge node. In some embodiments, the second request message may indicate at least one of: an identifier of the terminal device, an indicator indicating a planned location area where the terminal device will travel to, and an indicator indicating one or more V2X message types that are expected to be processed by the edge node. In some embodiments, the second response message may indicate at least one of: an indicator indicating the first geographical area, and an indicator indicating one or more message types that are supported by the edge node.

In some embodiments, the step of determining whether the V2X message is to be processed by the edge node or not may comprise that it may be determined that the V2X message is to be processed by the edge node in response to determining that the V2X message has a message type that is supported by the edge node. In some embodiments, the step of determining whether the V2X message is to be processed by the edge node or not may comprise that it may be determined that the V2X message is not to be processed by the edge node in response to determining that the V2X message has a message type that is not supported by the edge node. In some embodiments, the step of determining whether the V2X message is to be processed by the edge node or not may comprise that it may be determined that the V2X message is not to be processed by the edge node in response to determining that the terminal device is not located in the first geographical area indicated by the edge node.

In some embodiments, the step of receiving, from the edge node, a processing result for the V2X message may be performed in response to that a third request message for the processing result is transmitted to the edge node. In some embodiments, the third request message may be one of: a request message for retrieving the processing result for one time only, and a request message for subscribing a periodical notification of the processing result. In some embodiments, when the third request message is a request message for retrieving the processing result for one time only, the third request message may indicate at least one of: an identifier of the terminal device, and an indicator indicating a current location of the terminal device. In some embodiments, the processing result for the V2X message may be indicated by a third response message in response to the third request message. In some embodiments, the third response message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, a list of one or more events associated with the V2X object.

In some embodiments, when the third request message is a request message for subscribing a periodical notification of the processing result, the third request message may indicate at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method 1400 may further comprise that a third response message indicating a subscription identifier is received from the edge node in response to the third request message. In some embodiments, the processing result of the V2X message may be indicated by a notification message received from the edge node. In some embodiments, the notification message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, and a list of one or more events associated with the V2X object.

In some embodiments, the method 1400 may further comprise that a target edge node to which the terminal device is switched for offloading message processing may be determined. In some embodiments, the method 1400 may further comprise that a fourth request message may be transmitted to the target edge node to query the target edge node for an offloading area. In some embodiments, the method 1400 may further comprise that a fourth response message indicating a third geographical area where processing of a V2X message can be offloaded to the target edge node may be received from the target edge node. In some embodiments, the fourth request message may indicate at least one of: an identifier of the terminal device, an indicator indicating a planned location area where the terminal device will travel to, and an indicator indicating one or more V2X message types that are expected to be processed by the target edge node. In some embodiments, the fourth response message may indicate at least one of: an indicator indicating the third geographical area, and an indicator indicating one or more message types that are supported by the target edge node.

FIG. 15 is a flow chart of an exemplary method 1500 at an edge node for facilitating a terminal device in offloading message processing to the edge node according to an embodiment of the present disclosure. The method 1500 may be performed at a network node (e.g., the EAS 300 shown in FIG. 4). The method 1500 may comprise steps S1510, S1520, and S1530. However, the present disclosure is not limited thereto. In some other embodiments, the method 1500 may comprise more steps, less steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin at step S1510 where a received V2X message may be processed.

At step S1520, a third request message for a processing result for the V2X message may be received from a terminal device.

At step S1530, a processing result for the V2X message may be transmitted to the terminal device in response to the third request message.

In some embodiments, the third request message may be one of: a request message for retrieving the processing result for one time only, and a request message for subscribing a periodical notification of the processing result. In some embodiments, when the third request message is a request message for retrieving the processing result for one time only, the third request message may indicate at least one of: an identifier of the terminal device, and an indicator indicating a current location of the terminal device. In some embodiments, the processing result for the V2X message may be indicated by a third response message in response to the third request message. In some embodiments, the third response message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, a list of one or more events associated with the V2X object.

In some embodiments, when the third request message is a request message for subscribing a periodical notification of the processing result, the third request message may indicate at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method 1500 may further comprise that a third response message indicating a subscription identifier may be transmitted to the terminal device in response to the third request message. In some embodiments, the processing result of the V2X message may be indicated by a notification message transmitted by the edge node. In some embodiments, the notification message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, and a list of one or more events associated with the V2X object.

In some embodiments, before the step of receiving the third request message, the method 1500 may further comprise that a second request message may be received from the terminal device to query the edge node for an offloading area. In some embodiments, the method 1500 may further comprise that a second response message indicating a first geographical area where processing of a V2X message can be offloaded to the edge node may be transmitted to the terminal device. In some embodiments, the first geographical area may be determined at least based on one or more fourth geographical areas, each of which may be a geographical area where a relay terminal device, which is registered with the edge node, can listen to a V2X message over PC5. In some embodiments, the second request message may indicate at least one of: an identifier of the terminal device, an indicator indicating a planned location area where the terminal device will travel to, and an indicator indicating one or more V2X message types that are expected to be processed by the edge node. In some embodiments, the second response message may indicate at least one of: an indicator indicating the first geographical area, and an indicator indicating one or more message types that are supported by the edge node.

In some embodiments, before the step of receiving the V2X message, the method 1500 may further comprise that a fifth request message may be transmitted to a first network node to register the edge node with the first network node. In some embodiments, the method 1500 may further comprise that a fifth request message indicating whether the registration is successful or not may be received from the first network node in response to the fifth request message. In some embodiments, the fifth request message may indicate at least one of: an identifier of the edge node, endpoint information for the edge node, and an indicator indicating a fifth geographical area where the edge node can serve. In some embodiments, the fifth response message may indicate an identifier associated with the registration of the edge node.

In some embodiments, before the step of receiving the V2X message, the method 1500 may further comprise that a sixth request message may be received from a relay terminal device to register the relay terminal device with the edge node. In some embodiments, the method 1500 may further comprise that a sixth response message indicating whether the registration is successful or not may be transmitted to the relay terminal device in response to the sixth request message. In some embodiments, the sixth request message may indicate at least one of: an identifier of the relay terminal device, and an indicator indicating a fourth geographical area where the relay terminal device can listen to a V2X message over PC5. In some embodiments, the sixth response message may indicate at least one of: an identifier associated with the registration of the relay terminal device, and an indicator indicating one or more message types to be relayed by the relay terminal device. In some embodiments, the V2X message may be received via the relay terminal device.

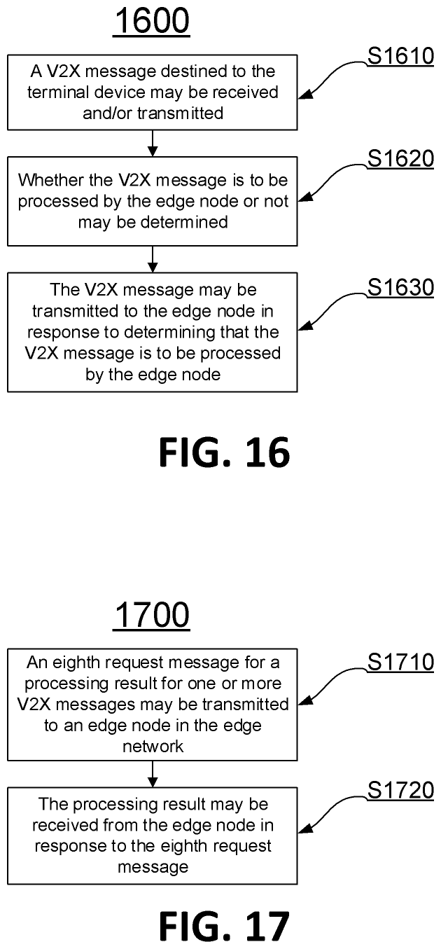

FIG. 16 is a flow chart of an exemplary method 1600 at a relay terminal device for facilitating a terminal device in offloading message processing to an edge node according to an embodiment of the present disclosure. The method 1600 may be performed at a relay terminal device (e.g., the RSU 110 shown in FIG. 4). The method 1600 may comprise steps S1610, S1620, and S1630. However, the present disclosure is not limited thereto. In some other embodiments, the method 1600 may comprise more steps, less steps, different steps, or any combination thereof. Further the steps of the method 1600 may be performed in a different order than that described herein. Further, in some embodiments, a step in the method 1600 may be split into multiple sub-steps and performed by different entities, and/or multiple steps in the method 1600 may be combined into a single step.

The method 1600 may begin at step S1610 where a V2X message destined to the terminal device may be received and/or transmitted.

At step S1620, whether the V2X message is to be processed by the edge node or not may be determined.

At step S1630, the V2X message may be transmitted to the edge node in response to determining that the V2X message is to be processed by the edge node.

In some embodiments, the method 1600 may further comprise that the V2X message may be discarded in response to determining that the V2X message is not to be processed by the edge node. In some embodiments, the step of determining whether the V2X message is to be processed by the edge node or not may comprise that it may be determined that the V2X message is to be processed by the edge node in response to determining that the V2X message has a message type that is supported by the edge node. In some embodiments, the step of determining whether the V2X message is to be processed by the edge node or not may comprise that it may be determined that the V2X message is not to be processed by the edge node in response to determining that the V2X message has a message type that is not supported by the edge node. In some embodiments, the method 1600 may further comprise that a seventh request message may be transmitted to a first network node to discover an edge node to which processing of a V2X message can be offloaded. In some embodiments, the method 1600 may further comprise that a seventh response message indicating one or more edge nodes to which processing of a V2X message can be offloaded may be received from the first network node. In some embodiments, the seventh request message may indicate at least one of: an identifier of the relay terminal device, one or more identifiers, each being associated with an application for which a V2X message is expected to be processed by the edge node, and an indicator indicating a current location of the relay terminal device. In some embodiments, the seventh response message may indicate at least one of: an identifier of each of the one or more edge nodes, and endpoint information for each of the one or more edge nodes.

In some embodiments, the method 1600 may further comprise that a sixth request message may be transmitted to the edge node to register the relay terminal device with the edge node. In some embodiments, the method 1600 may further comprise that a sixth response message indicating whether the registration is successful or not may be received from the edge node in response to the sixth request message. In some embodiments, the sixth request message may indicate at least one of: an identifier of the relay terminal device, and an indicator indicating a fourth geographical area where the relay terminal device can listen to a V2X message over PC5. In some embodiments, the sixth response message may indicate at least one of: an identifier associated with the registration of the relay terminal device, and an indicator indicating one or more message types to be relayed by the relay terminal device.

FIG. 17 is a flow chart of an exemplary method 1700 at a terminal device for obtaining a processing result for one or more V2X messages from an edge network according to an embodiment of the present disclosure. The method 1700 may be performed at a terminal device (e.g., the vehicle 100-9 shown in FIG. 4). The method 1700 may comprise steps S1710 and S1720. However, the present disclosure is not limited thereto. In some other embodiments, the method 1700 may comprise more steps, less steps, different steps, or any combination thereof. Further the steps of the method 1700 may be performed in a different order than that described herein. Further, in some embodiments, a step in the method 1700 may be split into multiple sub-steps and performed by different entities, and/or multiple steps in the method 1700 may be combined into a single step.

The method 1700 may begin at step S1710 where an eighth request message for a processing result for one or more V2X messages may be transmitted to an edge node in the edge network.

At step S1720, the processing result may be received from the edge node in response to the eighth request message.

In some embodiments, the eighth request message may be one of: a request message for retrieving the processing result for one time only, and a request message for subscribing a periodical notification of the processing result. In some embodiments, when the eighth request message is a request message for retrieving the processing result for one time only, the eighth request message may indicate at least one of: an identifier of the terminal device, and an indicator indicating a current location of the terminal device. In some embodiments, the processing result may be indicated by an eighth response message in response to the eighth request message. In some embodiments, the eighth response message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, and a list of one or more events associated with the V2X object.

In some embodiments, when the eighth request message is a request message for subscribing a periodical notification of the processing result, the eighth request message may indicate at least one of: an identifier of the terminal device, an indicator indicating a planned route where the terminal device will travel along, an indicator indicating a notification interval, an indicator indicating a subscription duration, and an indicator indicating a vehicle speed associated with the terminal device. In some embodiments, the method 1700 may further comprise that an eighth response message indicating a subscription identifier may be received from the edge node in response to the eighth request message. In some embodiments, the processing result may be indicated by a notification message received from the edge node. In some embodiments, the notification message may indicate at least one of: an indicator indicating a second geographical area relevant to the current location of the terminal device, a timestamp, a list of one or more V2X objects, and a list of one or more events. In some embodiments, a V2X object may indicate at least one of: a type of the V2X object, a location associated with the V2X object, additional information associated with the V2X object, and a list of one or more events associated with the V2X object.

In some embodiments, the method 1700 may further comprise that a ninth request message is transmitted to a first network node to discover an edge node from which a processing result for V2X messages can be retrieved. In some embodiments, the method 1700 may further comprise that a ninth response message indicating one or more edge nodes from which a processing result for V2X messages can be retrieved may be received from the first network node. In some embodiments, the ninth request message may indicate at least one of: an identifier of the terminal device, one or more identifiers, each being associated with an application for which a processing result for V2X messages is expected to be retrieved from the edge node, and an indicator indicating a current location of the terminal device. In some embodiments, the ninth response message may indicate at least one of: an identifier of each of the one or more edge nodes, and endpoint information for each of the one or more edge nodes.

In some embodiments, before the step of transmitting the eighth request message, the method 1700 may further comprise that a tenth request message may be transmitted to the edge node to query the edge node for an information retrieval area. In some embodiments, the method 1700 may further comprise that a tenth response message indicating a sixth geographical area where a processing result for V2X messages can be retrieved from the edge node may be received from the edge node. In some embodiments, the tenth request message may indicate at least one of: an identifier of the terminal device, an indicator indicating a planned location area where the terminal device will travel to, and an indicator indicating one or more V2X message types for which a processing result for V2X messages is expected to be retrieved from the edge node. In some embodiments, the tenth response message may indicate at least one of: an indicator indicating the sixth geographical area, and an indicator indicating one or more message types that are supported by the edge node.

In some embodiments, the method 1700 may further comprise that it may be determined a target edge node to which the terminal device is switched for retrieving the processing result. In some embodiments, the method 1700 may further comprise that an eleventh request message may be transmitted to the target edge node to query the target edge node for an information retrieval area. In some embodiments, the method 1700 may further comprise an eleventh response message indicating a seventh geographical area where the processing result can be retrieved from the target edge node may be received from the target edge node. In some embodiments, the eleventh request message may indicate at least one of: an identifier of the terminal device, an indicator indicating a planned location area where the terminal device will travel to, and an indicator indicating one or more V2X message types for which a processing result for V2X messages is expected to be retrieved from the target edge node. In some embodiments, the eleventh response message may indicate at least one of: an indicator indicating the seventh geographical area, and an indicator indicating one or more message types that are supported by the target edge node. In some embodiments, the terminal device itself may not support V2X communication.

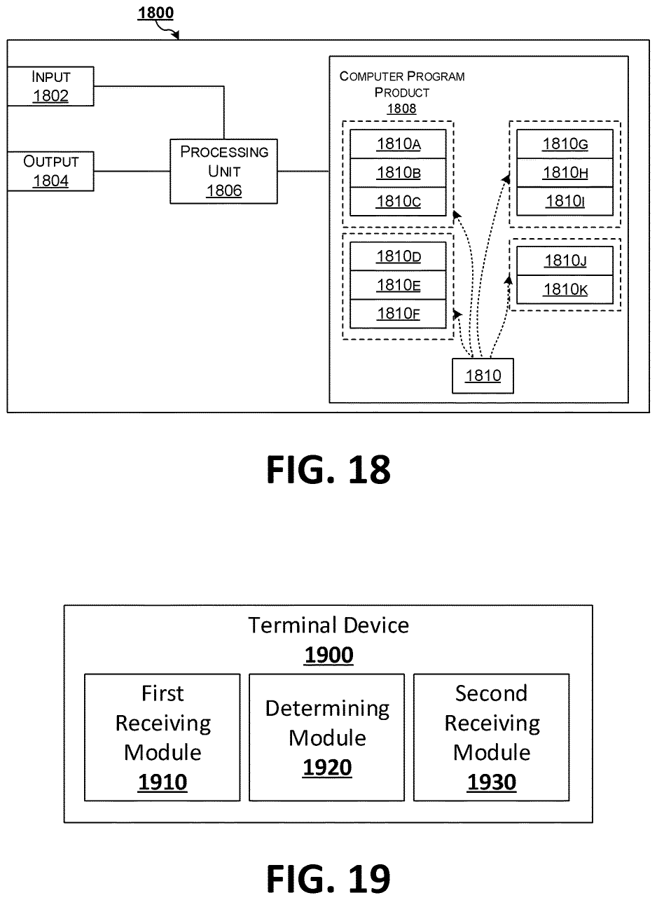

FIG. 18 schematically shows an embodiment of an arrangement which may be used in terminal devices and/or an edge node according to an embodiment of the present disclosure. Comprised in the arrangement 1800 are a processing unit 1806, e.g., with a Digital Signal Processor (DSP) or a Central Processing Unit (CPU). The processing unit 1806 may be a single unit or a plurality of units to perform different actions of procedures described herein. The arrangement 1800 may also comprise an input unit 1802 for receiving signals from other entities, and an output unit 1804 for providing signal(s) to other entities. The input unit 1802 and the output unit 1804 may be arranged as an integrated entity or as separate entities.

Furthermore, the arrangement 1800 may comprise at least one computer program product 1808 in the form of a non-volatile or volatile memory, e.g., an Electrically Erasable Programmable Read-Only Memory (EEPROM), a flash memory and/or a hard drive. The computer program product 1808 comprises a computer program 1810, which comprises code/computer readable instructions, which when executed by the processing unit 1806 in the arrangement 1800 causes the arrangement 1800 and/or the UEs and/or the network nodes in which it is comprised to perform the actions, e.g., of the procedure described earlier in conjunction with FIG. 5 through FIG. 17 or any other variant.

The computer program 1810 may be configured as a computer program code structured in computer program modules 1810A to 1810C. Hence, in an exemplifying embodiment when the arrangement 1800 is used in a terminal device, the code in the computer program of the arrangement 1800 includes: a module 1810A configured to receive, from another terminal device, a V2X message; a module 1810B configured to determine whether a received V2X message is to be processed by the edge node or not; and a module 1810C configured to receive, from the edge node, a processing result for the V2X message in response to determining that the V2X message is to be processed by the edge node.

Additionally or alternatively, the computer program 1810 may be further configured as a computer program code structured in computer program modules 1810D to 1810F. Hence, in an exemplifying embodiment when the arrangement 1800 is used in an edge node, the code in the computer program of the arrangement 1800 includes: a module 1810D configured to process a received V2X message; a module 1810E configured to receive, from a terminal device, a third request message for a processing result for the V2X message; and a module 1810F configured to transmit, to the terminal device, a processing result for the V2X message in response to the third request message.

Additionally or alternatively, the computer program 1810 may be further configured as a computer program code structured in computer program modules 1810G to 1810I. Hence, in an exemplifying embodiment when the arrangement 1800 is used in a relay terminal device, the code in the computer program of the arrangement 1800 includes: a module 1810G configured to receive and/or transmit a V2X message destined to the terminal device; a module 1810H configured to determine whether the V2X message is to be processed by the edge node or not; and a module 1810I configured to transmit, to the edge node, the V2X message in response to determining that the V2X message is to be processed by the edge node.

Additionally or alternatively, the computer program 1810 may be further configured as a computer program code structured in computer program modules 1810J to 1810K. Hence, in an exemplifying embodiment when the arrangement 1800 is used in a terminal device, the code in the computer program of the arrangement 1800 includes: a module 1810J configured to transmit, to an edge node in the edge network, an eighth request message for a processing result for one or more V2X messages; and a module 1810K configured to receive, from the edge node, the processing result in response to the eighth request message.

The computer program modules could essentially perform the actions of the flow illustrated in FIG. 5 through FIG. 17, to emulate the terminal devices and/or the edge node. In other words, when the different computer program modules are executed in the processing unit 1806, they may correspond to different modules in the terminal device, the edge node, the relay terminal device, and/or the (legacy) terminal device.

Although the code means in the embodiments disclosed above in conjunction with FIG. 18 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

Correspondingly to the method 1400 as described above, an exemplary terminal device is provided. FIG. 19 is a block diagram of an exemplary terminal device 1900 according to an embodiment of the present disclosure. The terminal device 1900 may be, e.g., the vehicle 100-3 in some embodiments.

The terminal device 1900 may be configured to perform the method 1400 as described above in connection with FIG. 14. As shown in FIG. 19, the terminal device 1900 may comprise a first receiving module 1910 configured to receive, from another terminal device, a V2X message; a determining module 1920 configured to determine whether a received V2X message is to be processed by the edge node or not; and a second receiving module 1930 configured to receive, from the edge node, a processing result for the V2X message in response to determining that the V2X message is to be processed by the edge node.

The above modules 1910, 1920, and/or 1930 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 14. Further, the terminal device 1900 may comprise one or more further modules, each of which may perform any of the steps of the method 1400 described with reference to FIG. 14.

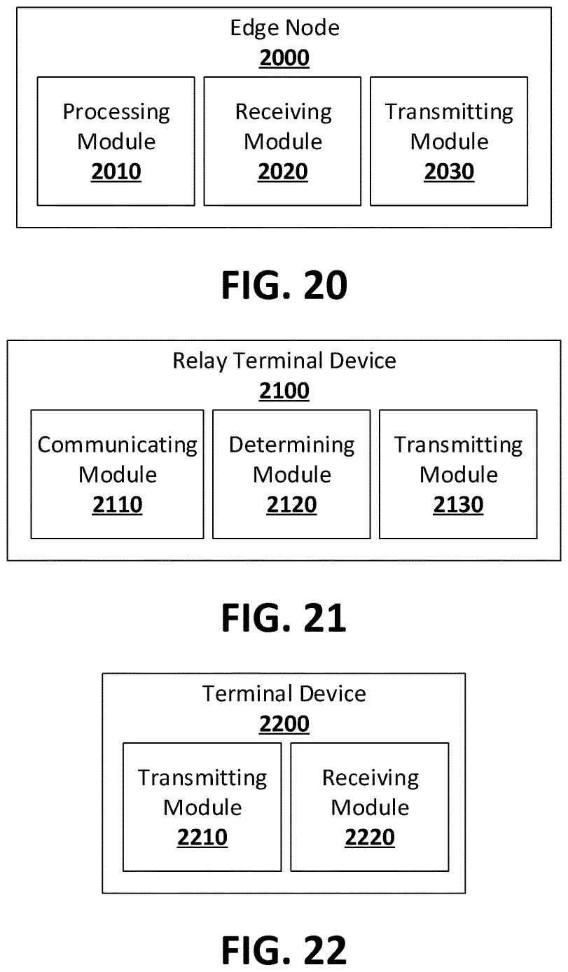

Correspondingly to the method 1500 as described above, an exemplary edge node is provided. FIG. 20 is a block diagram of an exemplary edge node 2000 according to an embodiment of the present disclosure. The edge node 2000 may be, e.g., the EAS 300 in some embodiments.

The edge node 2000 may be configured to perform the method 1500 as described above in connection with FIG. 15. As shown in FIG. 20, the edge node 2000 may comprise a processing module 2010 configured to process a received V2X message; a receiving module 2020 configured to receive, from a terminal device, a third request message for a processing result for the V2X message; and a transmitting module 2030 configured to transmit, to the terminal device, a processing result for the V2X message in response to the third request message.

The above modules 2010, 2020, and/or 2030 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 15. Further, the edge node 2000 may comprise one or more further modules, each of which may perform any of the steps of the method 1500 described with reference to FIG. 15.

Correspondingly to the method 1600 as described above, an exemplary relay terminal device is provided. FIG. 21 is a block diagram of an exemplary relay terminal device 2100 according to an embodiment of the present disclosure. The relay terminal device 2100 may be, e.g., the RSU 110 in some embodiments.

The relay terminal device 2100 may be configured to perform the method 1600 as described above in connection with FIG. 16. As shown in FIG. 21, the relay terminal device 2100 may comprise a communicating module 2110 configured to receive and/or transmit a V2X message destined to the terminal device; a determining module 2120 configured to determine whether the V2X message is to be processed by the edge node or not; a transmitting module 2130 configured to transmit, to the edge node, the V2X message in response to determining that the V2X message is to be processed by the edge node.

The above modules 2110, 2120, and/or 2130 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 16. Further, the relay terminal device 2100 may comprise one or more further modules, each of which may perform any of the steps of the method 1600 described with reference to FIG. 16.

Correspondingly to the method 1700 as described above, an exemplary terminal device is provided. FIG. 22 is a block diagram of an exemplary terminal device 2200 according to an embodiment of the present disclosure. The terminal device 2200 may be, e.g., the legacy vehicle 100-9 in some embodiments.

The terminal device 2200 may be configured to perform the method 1700 as described above in connection with FIG. 17. As shown in FIG. 22, the terminal device 2200 may comprise a transmitting module 2210 configured to transmit, to an edge node in the edge network, an eighth request message for a processing result for one or more V2X messages; and a receiving module 2220 configured to receive, from the edge node, the processing result in response to the eighth request message.

The above modules 2210 and/or 2220 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 17. Further, the terminal device 2200 may comprise one or more further modules, each of which may perform any of the steps of the method 1700 described with reference to FIG. 17.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| C-V2X | Cellular Vehicle-to-Everything |
| EAS | Edge Application Server |
| RSU | Road-Side Unit |
| T-EAS | Target Edge Application Server |
| V2E2V | Vehicle-to-Edge-to-Vehicle |
| V2I | Vehicle-to-Infrastructure |
| V2N | Vehicle-to-Network |
| V2P | Vehicle-to-Pedestrian |
| V2N2V | Vehicle-to-Network-to-Vehicle |
| V2V | Vehicle-to-Vehicle |
| V2X | Vehicle-to-Everything |

1. A method at a terminal device for offloading message processing to an edge node, the method comprising:
receiving, from another terminal device, a Vehicle-to-Everything (V2X) message;
determining whether the received V2X message is to be processed by the edge node or not; and
receiving, from the edge node, a processing result for the V2X message in response to determining that the V2X message is to be processed by the edge node.

2. The method of claim 1, further comprising at least one of:
discarding the V2X message in response to determining that the V2X message is to be processed by the edge node; and
processing the V2X message locally in response to determining that the V2X message is not to be processed by the edge node.

3. The method of claim 1, further comprising:
transmitting, to a first network node, a first request message to discover an edge node to which processing of a V2X message can be offloaded; and
receiving, from the first network node, a first response message indicating one or more edge nodes to which processing of a V2X message can be offloaded.

4.-5. (canceled)

6. The method of claim 1, wherein before the step of receiving the V2X message, the method further comprises:
transmitting, to the edge node, a second request message to query the edge node for an offloading area; and
receiving, from the edge node, a second response message indicating a first geographical area where processing of a V2X message can be offloaded to the edge node.

7.-8. (canceled)

9. The method of claim 1, wherein the step of determining whether the V2X message is to be processed by the edge node or not comprises at least one of:
determining that the V2X message is to be processed by the edge node in response to determining that the V2X message has a message type that is supported by the edge node;
determining that the V2X message is not to be processed by the edge node in response to determining that the V2X message has a message type that is not supported by the edge node; and
determining that the V2X message is not to be processed by the edge node in response to determining that the terminal device is not located in the first geographical area indicated by the edge node.

10. The method of claim 1, wherein the step of receiving, from the edge node, a processing result for the V2X message is performed in response to:
transmitting, to the edge node, a third request message for the processing result.

11.-16. (canceled)

17. The method of claim 10, further comprising:
receiving, from the edge node, a third response message indicating a subscription identifier in response to the third request message.

18. The method of claim 10, wherein the processing result of the V2X message is indicated by a notification message received from the edge node.

19.-20. (canceled)

21. The method of claim 1, further comprising:
determining a target edge node to which the terminal device is switched for offloading message processing;
transmitting, to the target edge node, a fourth request message to query the target edge node for an offloading area; and
receiving, from the target edge node, a fourth response message indicating a third geographical area where processing of a V2X message can be offloaded to the target edge node.

22.-23. (canceled)

24. A terminal device, comprising:
a processor;
a memory storing instructions which, when executed by the processor, cause the processor to:
receive, from another terminal device, a Vehicle-to-Everything (V2X) message;
determine whether the received V2X message is to be processed by the edge node or not; and
receive, from the edge node, a processing result for the V2X message in response to determining that the V2X message is to be processed by the edge node.

25. A method at an edge node for facilitating a terminal device in offloading message processing to the edge node, the method comprising:
processing a received V2X message;
receiving, from a terminal device, a third request message for a processing result for the V2X message; and
transmitting, to the terminal device, a processing result for the V2X message in response to the third request message.

26.-35. (canceled)

36. The method of claim 25, wherein
before the step of receiving the third request message, the method further comprises:
receiving, from the terminal device, a second request message to query the edge node for an offloading area; and
transmitting, to the terminal device, a second response message indicating a first geographical area where processing of a V2X message can be offloaded to the edge node.

37. The method of claim 36, wherein the first geographical area is determined at least based on one or more fourth geographical areas, each of which is a geographical area where a relay terminal device, which is registered with the edge node, can listen to a V2X message over PC5.

38.-39. (canceled)

40. The method of claim 25, wherein
before the step of receiving the V2X message, the method further comprises:
transmitting, to a first network node, a fifth request message to register the edge node with the first network node; and
receiving, from the first network node, a fifth request message indicating whether the registration is successful or not in response to the fifth request message.

41.-42. (canceled)

43. The method of claim 25, wherein
before the step of receiving the V2X message, the method further comprises:
receiving, from a relay terminal device, a sixth request message to register the relay terminal device with the edge node; and
transmitting, to the relay terminal device, a sixth response message indicating whether the registration is successful or not in response to the sixth request message.

44.-45. (canceled)

46. The method of claim 43, wherein the V2X message is received via the relay terminal device.

47.-83. (canceled)
